(19) United States
(12) Patent Application Publication
(10) Pub. No.: US 2025/0068916 A1
(43) Pub. Date: Feb. 27, 2025

(54) SYSTEMS, APPARATUS, ARTICLES OF MANUFACTURE, AND METHODS FOR TEACHER-FREE SELF-FEATURE DISTILLATION TRAINING OF MACHINE LEARNING MODELS

(71) Applicant: Intel Corporation, Santa Clara, CA (US)

(72) Inventors: Yurong Chen, Beijing (CN); Anbang Yao, Beijing (CN); Yi Qian, Shanghai (CN); Yu Zhang, Beijing (CN); Shandong Wang, Beijing (CN)

(21) Appl. No.: 18/725,028

(22) PCT Filed: Feb. 21, 2022
(86) PCT No.: PCT/CN2022/077004

§ 371 Date: Jun. 28, 2024

(51) Int. Cl. G06N 3/088

(52) U.S. Cl. CPC G06N 3/088

(57) ABSTRACT

Methods, apparatus, systems, and articles of manufacture are disclosed for teacher-free self-feature distillation training of machine-learning (ML) models. An example apparatus includes at least one memory, instructions, and processor circuitry to at least one of execute or instantiate the instructions to perform a first comparison of (i) a first group of a first set of feature channels (FCs) of an ML model and (ii) a second group of the first set, perform a second comparison of (iii) a first group of a second set of FCs of the ML model and one of (iv) a third group of the first set or a first group of a third set of FCs of the ML model, adjust parameter(s) of the ML model based on the first and/or second comparisons, and, in response to an error value satisfying a threshold, deploy the ML model to execute a workload based on the parameter(s).

### FIELD OF THE DISCLOSURE

This disclosure relates generally to machine learning and, more particularly, to systems, apparatus, articles of manufacture, and methods for teacher-free self-feature distillation training of machine learning models.

### BACKGROUND

Machine learning models, such as neural networks, are useful tools that have demonstrated their value solving complex problems regarding pattern recognition, natural language processing, automatic speech recognition, etc. Neural networks operate, for example, using artificial neurons arranged into layers that process data from an input layer to an output layer and apply weighting values to the data during the processing of the data. Such weighting values are determined during a training process.

### BRIEF DESCRIPTION OF THE DRAWINGS

FIG. 1 is an illustration of an example electronic system including example model training circuitry.

FIG. 2 is an illustration of an example machine learning model architecture.

FIG. 3 is a first portion of the example machine learning model architecture of FIG. 2.

FIG. 4 is a second portion of the example machine learning model architecture of FIG. 2.

FIG. 5 is a block diagram of an example implementation of the example model training circuitry of FIG. 1.

FIG. 6 is a flowchart representative of example machine readable instructions and/or example operations that may be executed by example processor circuitry to implement the example model training circuitry of FIGS. 1 and/or 5 for teacher-free self-feature distillation training of a machine learning model.

FIG. 7 is a flowchart representative of example machine readable instructions and/or example operations that may be executed by example processor circuitry to implement the example model training circuitry of FIGS. 1 and/or 5 to determine a first error value of a first loss function.

FIG. 8 is a flowchart representative of example machine readable instructions and/or example operations that may be executed by example processor circuitry to implement the example model training circuitry of FIGS. 1 and/or 5 to determine a second error value of a second loss function.

FIG. 9 is another flowchart representative of example machine readable instructions and/or example operations that may be executed by example processor circuitry to implement the example model training circuitry of FIGS. 1 and/or 5 for teacher-free self-feature distillation training of a machine learning model.

FIGS. 10A-10D are tables depicting example improvements of training a machine learning model with examples disclosed herein with respect to conventional machine learning model training techniques.

FIG. 11 is a block diagram of an example processing platform including processor circuitry structured to execute the example machine readable instructions and/or the example operations of FIGS. 6, 7, 8, and/or 9 to implement the example model training circuitry of FIGS. 1 and/or 5.

FIG. 12 is a block diagram of an example implementation of the processor circuitry of FIG. 11.

FIG. 13 is a block diagram of another example implementation of the processor circuitry of FIG. 11.

FIG. 14 is a block diagram of an example software distribution platform (e.g., one or more servers) to distribute software (e.g., software corresponding to the example machine readable instructions of FIGS. 6, 7, 8, and/or 9) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

### DETAILED DESCRIPTION

In general, the same reference numbers will be used throughout the drawing(s) and accompanying written description to refer to the same or like parts. The figures are not to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an clement in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processor circuitry is/are best suited to execute the computing task(s).

Machine learning models, such as neural networks (e.g., artificial neural networks (ANNs), convolution neural networks (CNNs), deep neural networks (DNNs), etc.), are useful tools that have demonstrated their value solving complex problems regarding pattern recognition, natural language processing, automatic speech recognition, etc. Neural networks operate, for example, using artificial neurons arranged into layers that process data from an input layer to an output layer and apply weighting values to the data during the processing of the data. Such weighting values are determined during a training process.

In particular, DNNs are utilized for a variety of Artificial Intelligence and/or Machine Learning (AI/ML) applications, such as image recognition, video understanding, and the like. Typical DNN architectures have a substantially large number of learnable parameters that are stacked using complex network topologies, which gives them improved ability to fit training data with respect to other types of AI/ML techniques. However, such a substantially large number of stacked learnable parameters may lead to (i) increased computation, memory, and/or power costs during inference and/or (ii) increased difficulty of model training.

Some techniques to train a machine learning model, such as a DNN, are knowledge distillation techniques. Knowledge distillation techniques are used in AI/ML applications such as action recognition, depth estimation, efficient network design, facial recognition, image recognition, lifelong learning, machine translation, object detection, person re-identification, scene parsing, speech recognition, and style transfer. Knowledge distillation techniques implement processes of transferring knowledge from a large, pre-trained model (e.g., a first machine learning model having a first number of layers, a first number of parameters, etc.) to a small, untrained model (e.g., a second machine learning model having a second number of layers smaller than the first number of layers, a second number of parameters smaller than the first number of parameters, etc.). For example, the large model may be a teacher model and the small model may be a student model. In some examples, the teacher model may teach the student model by outputting soft labels (e.g., labels associated with a respective probability or a likelihood) and causing the student model to learn the behavior (e.g., an exact behavior, a substantially similar behavior, etc.) of the teacher model by attempting to replicate the teacher model's outputs at one or more levels of the student model.

Some knowledge distillation techniques may include two-stage techniques and one-stage techniques. Two-stage knowledge distillation techniques may include pre-training a large, teacher model during a first stage and training a small, target student model guided by outputs predicted by the pre-trained large teacher model during a second stage. One-stage knowledge distillation techniques may include using an online framework to train collaboratively and substantially simultaneously a large, teacher model and a small, student model from an initial state. Some such knowledge distillation techniques have limitations. For example, some such knowledge distillation techniques assume that, given a student or target network, a well-defined teacher network is available, which is difficult to meet in real, practical applications. Knowledge distillation techniques may also have substantially heavy training costs, which may be as high as at least N (e.g., N=3, 11, 20, etc.) times greater than training a single student model. Some knowledge distillation techniques may need student-specific manual parameter tunings, which may lead to inefficiencies and lower accuracy. Some such knowledge distillation techniques are not user friendly in real, practical applications.

Examples disclosed herein include a user-friendly, parameter-free, and efficient knowledge distillation technique for training AI/ML models, such as neural networks, without teacher model(s). Examples disclosed herein include a knowledge distillation technique that implements a teacher-free self-feature distiller (Tf-SfD) for high-performance AI/ML applications. The disclosed knowledge distillation technique is a teacher-free technique because a teacher model (e.g., a teacher neural network) is not used to teach and/or otherwise train a student model (e.g., a student or target neural network). For example, the knowledge distillation technique can be teacher-free by training a small, lightweight machine learning model without a larger machine learning model. The disclosed knowledge distillation technique is also a self-feature technique because a machine learning model may be trained using its own features as disclosed herein. Advantageously, the example knowledge distillation technique disclosed herein has reduced training costs and simpler parameter tunings with respect to typical knowledge distillation techniques.

In some disclosed examples, the knowledge distillation technique described herein includes self-feature distillation operations, which includes an inter-layer operation (e.g., an inter-layer Tf-SfD operation) and an intra-layer operation (e.g., an intra-layer Tf-SfD operation). Advantageously, the inter-layer Tf-SfD and intra-layer Tf-SfD operations are parameter free when acting as the auxiliary loss functions and, thereby, reduce the need for extra parameters when training the AI/ML model.

In some disclosed examples, an inter-layer Tf-SfD operation squeezes (e.g., compresses) and transfers feature knowledge in deeper layers of an AI/ML model to shallower layers of the AI/ML model by utilizing a cross-layer feature mimicking technique. For example, the deeper layers of the AI/ML model may teach the shallower layers of the AI/ML model to emulate the outputs of the deeper layers.

In some disclosed examples, an intra-layer Tf-SfD operation divides feature channels at the same layer into two or more disjoint groups having the same number of channels (e.g., a first group with salient feature channels, a second group with non-salient feature channels, etc.). For example, the intra-layer Tf-SfD operation may cause the group with non-salient feature channels to mimic, imitate, etc., the group with salient feature channels at the same layer. For example, the group with salient features may teach the group with non-salient features to emulate the outputs of the group with salient features.

Advantageously, the inter-layer Tf-SfD operation and intra-layer Tf-SfD operation as disclosed herein achieve improved model accuracy and performance while reducing training costs and complexity in parameter tunings. For example, the knowledge distillation technique as disclosed herein may utilize the inter-layer Tf-SfD operation and/or the intra-layer Tf-SfD operation to convert a computationally intensive neural network into a lightweight neural network with substantially similar accuracy, which, from a hardware perspective, may achieve the replacement of deep, sequential processing with parallel, distributed processing for improved hardware efficiency and reduced computational costs during training and/or inference.

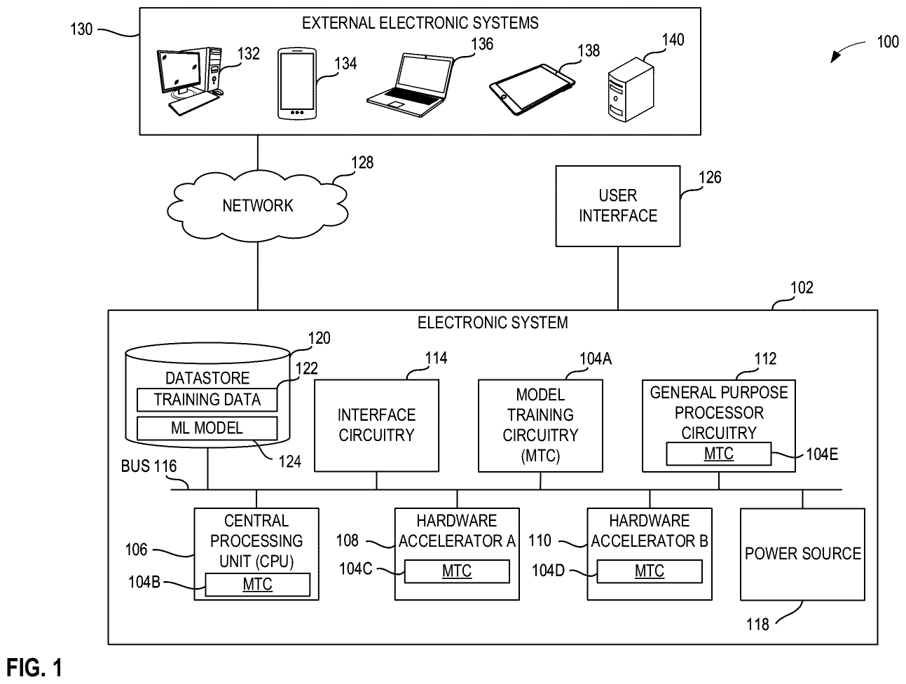

FIG. 1 is an illustration of an example computing environment 100 including an example electronic system 102, which includes example model training circuitry 104A-E to effectuate training and deployment of a machine learning model. The electronic system 102 of the illustrated example of FIG. 1 includes an example central processing unit (CPU) 106, a first example hardware accelerator (identified by HARDWARE ACCELERATOR A) 108, a second example hardware accelerator (identified by HARDWARE ACCELERATOR B) 110, example general purpose processor circuitry 112, example interface circuitry 114, an example bus 116, an example power source 118, and an example datastore 120. The datastore 120 of the illustrated example of FIG. 1 includes example training data 122 and an example machine learning model (ML MODEL) 124. Additionally and/or alternatively, the datastore 120 may store any number and/or type(s) of machine learning model. Further depicted in the illustrated example of FIG. 1 is an example user interface 126, an example network 128, and example external electronic systems 130.

In the illustrated example of FIG. 1, the electronic system 102 is a combination of hardware, software, and/or firmware (e.g., a computing device) on which the ML model 124 is to be trained, deployed, instantiated, and/or executed. In some examples, the electronic system 102 is a mobile device, such as a cell or mobile phone (e.g., an Internet-enabled smartphone), a tablet computer (e.g., an Internet-enabled tablet), etc. For example, the electronic system 102 can be implemented as a mobile phone having one or more processors (e.g., a CPU, a digital signal processor (DSP), a graphics processing unit (GPU), a vision processing unit (VPU), an artificial intelligence (AI) and/or neural-network (NN) specific processor, etc.) on one or more system-on-a-chip (SoC) substrates. In some examples, the electronic system 102 is a desktop computer, a laptop computer, a server, etc. For example, the electronic system 102 can be implemented as a desktop computer, a laptop computer, a server, etc., having one or more processors (e.g., a CPU, a GPU, a VPU, an AI/NN specific processor, etc.) on one or more SoCs.

In some examples, the electronic system 102 is an SoC representative of one or more integrated circuits (ICs) (e.g., compact ICs) that incorporate components of a computer or other electronic system in a compact format. For example, the electronic system 102 may be implemented with a combination of one or more programmable processors, hardware logic, and/or hardware peripherals and/or interfaces. Additionally or alternatively, the example electronic system 102 of FIG. 1 may include memory, input/output (I/O) port(s), and/or secondary storage. For example, the electronic system 102 includes the model training circuitry 104A-E, the CPU 106, the first hardware accelerator 108, the second hardware accelerator 110, the general purpose processor circuitry 112, the interface circuitry 114, the bus 116, the power source 118, the datastore 120, the memory, the I/O port(s), and/or the secondary storage all on the same substrate. In some examples, the electronic system 102 includes digital, analog, mixed-signal, radio frequency (RF), or other signal processing functions.

In the illustrated example of FIG. 1, the first hardware accelerator 108 is a GPU. For example, the first hardware accelerator 108 can be a GPU that generates computer graphics, executes general-purpose computing, etc. In some examples, the first hardware accelerator 108 processes AI/ML tasks. For example, the first hardware accelerator 108 can execute and/or otherwise implement a neural network, such as an artificial neural network (ANN), a convolution neural network (CNN), a deep neural network (DNN), a recurrent neural network (RNN), etc.

The second hardware accelerator 110 of the illustrated example of FIG. 1 is a VPU. For example, the second hardware accelerator 110 can effectuate machine or computer vision computing tasks. In some examples, the second hardware accelerator 110 can execute and/or otherwise implement a neural network, such as an ANN, a CNN, a DNN, an RNN, etc.

The general purpose processor circuitry 112 of the illustrated example of FIG. 1 is a programmable processor, such as a CPU, a DSP, or a GPU. In some examples, the general purpose processor circuitry 112 completes AI/ML tasks. For example, the general purpose processor circuitry 112 can execute and/or otherwise implement a neural network, such as an ANN, a CNN, a DNN, an RNN, etc. Additionally and/or alternatively, one or more of the CPU 106, the first hardware accelerator 108, the second hardware accelerator 110, and/or the general purpose processor circuitry 112 may be a different type of hardware such as a DSP, an application specific integrated circuit (ASIC), a programmable logic device (PLD), and/or a field programmable logic device (FPLD) (e.g., a field-programmable gate array (FPGA)).

In the illustrated example of FIG. 1, the interface circuitry 114 can be representative of and/or otherwise implement one or more interfaces. For example, the interface circuitry 114 can be implemented by a communication device (e.g., a network interface card (NIC), a smart NIC, an Infrastructure Processing Unit (IPU), etc.) such as a transmitter, a receiver, a transceiver, a modem, a residential gateway, a wireless access point, and/or a network interface to facilitate exchange of data with external machines (e.g., computing devices of any kind) via the network 128. In some examples, the communication is effectuated via an Ethernet connection, a digital subscriber line (DSL) connection, a telephone line connection, a coaxial cable system, a satellite system, a beyond line-of-site wireless system, a line-of-site wireless system, a cellular telephone system, etc. For example, the interface circuitry 114 can be implemented by any type of interface standard, such as a wireless fidelity (Wi-Fi) interface, an Ethernet interface, a universal serial bus (USB), a Bluetooth interface, a near field communication (NFC) interface, a Peripheral Component Interconnect (PCI) interface, and/or a Peripheral Component Interconnect express (PCI-e or PCIe) interface.

The electronic system 102 of the illustrated example includes the power source 118 to deliver power to portion(s) of the electronic system 102. In the illustrated example of FIG. 1, the power source 118 is a battery. For example, the power source 118 can be a limited-energy device, such as a lithium-ion battery or any other chargeable battery or power source. In some examples, the power source 118 is chargeable using a power adapter or converter (e.g., an alternating current (AC) to direct current (DC) power converter), a wall outlet (e.g., a 120V AC wall outlet, a 224V AC wall outlet, etc.), etc.

The electronic system 102 of the illustrated example of FIG. 1 includes the datastore 120 to record data (e.g., the training data 122, the ML model 124, etc.). The datastore 120 of this example can be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The datastore 120 may additionally and/or alternatively be implemented by one or more double data rate (DDR) memories, such as DDR, DDR2, DDR3, DDR4, DDR5, mobile DDR (mDDR), etc. The datastore 120 may additionally and/or alternatively be implemented by one or more mass storage devices such as hard disk drive(s) (HDD(s)), compact disk (CD) drive(s), digital versatile disk (DVD) drive(s), solid-state disk (SSD) drive(s), etc. While in the illustrated example the datastore 120 is illustrated as a single datastore, the datastore 120 may be implemented by any number and/or type(s) of datastores. Furthermore, the data stored in the datastore 120 may be in any data format such as, for example, binary data, comma delimited data, tab delimited data, structured query language (SQL) structures, executable files (e.g., AI/ML executable files, AI/ML configuration images, etc.).

In the illustrated example of FIG. 1, the datastore 120, and/or, more generally, the electronic system 102, stores the training data 122 to be used as model inputs for training the ML model 124. For example, the training data 122 can be any type of data, such as images (e.g., image data), video clips (e.g., video data), labels (e.g., hard labels, soft labels, etc.), etc., and/or any combination thereof.

In the illustrated example of FIG. 1, the datastore 120, and/or, more generally, the electronic system 102, stores the ML model 124 to facilitate the training, deployment, and/or execution of the ML model 124 on the electronic system 102 and/or one(s) of the external electronic systems 130. In some examples, the ML model 124 can be a baseline machine learning model, such as an untrained machine learning model or a machine learning model that has been trained (e.g., pre-trained, trained, etc.) with a conventional machine learning model training technique (e.g., a conventional knowledge distillation technique). In some examples, the ML model 124 can be a machine learning model trained by the model training circuitry 104A-E, which can train the ML model 124 based on the training data 122.

In the illustrated example of FIG. 1, the electronic system 102 is in communication with the user interface 126. For example, the user interface 126 is a graphical user interface (GUI), an application display, etc., presented to a user on a display device in circuit with and/or otherwise in communication with the electronic system 102 via one or more display interfaces (e.g., a Video Graphics Array (VGA) interface, a Digital Visual Interface (DVI), a High-Definition Multimedia Interface (HDMI), a DisplayPort interface, etc.). In some examples, a user can control the electronic system 102, adjust a machine learning model training parameter (e.g., a learning rate, a number of layers to be used in the ML model 124, etc.) to train the ML model 124, etc., via the user interface 126. Additionally and/or alternatively, the electronic system 102 may include the user interface 126.

In the illustrated example of FIG. 1, the model training circuitry 104A-E, the CPU 106, the first hardware accelerator 108, the second hardware accelerator 110, the general purpose processor circuitry 112, the interface circuitry 114, the power source 118, and the datastore 120 are in communication with the bus 116. For example, the bus 116 can correspond to, be representative of, and/or otherwise implement at least one of an Inter-Integrated Circuit (I2C) bus, a Serial Peripheral Interface (SPI) bus, a PCI bus, or a PCIe bus.

The network 128 of the illustrated example of FIG. 1 is the Internet. However, the network 128 of this example may be implemented using any suitable wired and/or wireless network(s) including, for example, one or more data buses, one or more Local Area Networks (LANs), one or more wireless LANs, one or more cellular networks, one or more private networks, one or more public networks, one or more satellite networks, etc. The network 128 can enable the electronic system 102 to be in communication with the external electronic systems 130.

In the illustrated example of FIG. 1, the external electronic systems 130 are devices (e.g., computing devices) on which the ML model 124 can be executed. In this example, the external electronic systems 130 include an example desktop computer 132, an example mobile device (e.g., a smartphone, an Internet-enabled smartphone, etc.) 124, an example laptop computer 136, an example tablet (e.g., a tablet computer, an Internet-enabled tablet computer, etc.) 138, and an example server 140. In some examples, fewer or more electronic systems than depicted in FIG. 1 may be used. Additionally and/or alternatively, the external electronic systems 130 may include, correspond to, and/or otherwise be representative of any other type of electronic device.

In some examples, one or more of the external electronic systems 130 execute the ML model 124 to process a workload (e.g., an AI/ML workload, a computing workload, etc.). For example, the mobile device 134 can be implemented as a cellular or mobile phone having one or more processors (e.g., a CPU, a GPU, a VPU, an AI/NN specific processor, etc.) on one or more SoCs to process an AI/ML workload using the ML model 124. For example, the desktop computer 132, the mobile device 134, the laptop computer 136, the tablet computer 138, and/or the server 140 can be implemented as electronic device(s) having one or more processors (e.g., a CPU, a GPU, a VPU, an AI/NN specific processor, etc.) on one or more SoCs to process an AI/ML workload using the ML model 124. In some examples, the server 140 includes and/or otherwise is representative of one or more servers that can implement a central facility, a data facility, a cloud service (e.g., a public or private cloud provider, a cloud-based repository, etc.), a research institution (e.g., a laboratory, a research and development organization, a university, etc.), etc., to process AI/ML workload(s) using the ML model 124.

In the illustrated example of FIG. 1, the electronic system 102 includes first model training circuitry 104A (e.g., a first instance of the model training circuitry 104A-E), second model training circuitry 104B (e.g., a second instance of the model training circuitry 104A-E), third model training circuitry 104C (e.g., a third instance of the model training circuitry 104A-E), fourth model training circuitry 104D (e.g., a fourth instance of the model training circuitry 104A-E), and fifth model training circuitry 104E (e.g., a second instance of the model training circuitry 104A-E) (collectively referred to herein as the model training circuitry 104A-E unless otherwise specified herein). In the illustrated example of FIG. 1, the first model training circuitry 104A can be implemented by hardware, software, and/or firmware. For example, the first model training circuitry 104A can be implemented by one or more analog or digital circuit(s), logic circuits, programmable processor(s), programmable controller(s), GPU(s), VPU(s), DSP(s), ASIC(s), PLD(s), FPLD(s), etc., and/or any combination(s) thereof.

In the illustrated example of FIG. 1, the second model training circuitry 104B is implemented by the CPU 106, the third model training circuitry 104C is implemented by the first hardware accelerator 108, the fourth model training circuitry 104D is implemented by the second hardware accelerator 110, and the fifth model training circuitry 104E is implemented by the general purpose processor circuitry 112. Additionally and/or alternatively, the first model training circuitry 104A, the second model training circuitry 104B, the third model training circuitry 104C, the fourth model training circuitry 104D, the fifth model training circuitry 104E, and/or portion(s) thereof, may be virtualized, such as by being implemented using one or more virtual machines (VMs), one or more containers, etc. Additionally and/or alternatively, the first model training circuitry 104A, the second model training circuitry 104B, the third model training circuitry 104C, the fourth model training circuitry 104D, and/or the fifth model training circuitry 104E may be implemented by different portion(s) of the electronic system 102, such as the first hardware accelerator 108, the second hardware accelerator 110, etc. Alternatively, the electronic system 102 may not include the first model training circuitry 104A, the second model training circuitry 104B, the third model training circuitry 104C, the fourth model training circuitry 104D, and/or the fifth model training circuitry 104E.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model training circuitry 104A-E may train the ML model 124 with data (e.g., the training data 122) to recognize patterns and/or associations and follow such patterns and/or associations when processing input data such that other input(s) result in output(s) consistent with the recognized patterns and/or associations.

Many different types of machine-learning models and/or machine-learning architectures exist. In some examples, the model training circuitry 104A-E generates the ML model 124 as neural network model(s). The model training circuitry 104A-E may invoke the interface circuitry 114 to transmit the ML model 124 to one(s) of the external electronic systems 130. Using a neural network model enables the hardware accelerators 108, 110 to execute an AI/ML workload. In general, machine-learning models/architectures that are suitable to use in the example approaches disclosed herein include recurrent neural networks. However, other types of machine learning models could additionally or alternatively be used such as supervised learning ANN models, clustering models, classification models, etc., and/or a combination thereof. Example supervised learning ANN models may include two-layer (2-layer) radial basis neural networks (RBN), learning vector quantization (LVQ) classification neural networks, etc. Example clustering models may include k-means clustering, hierarchical clustering, mean shift clustering, density-based clustering, etc. Example classification models may include logistic regression, support-vector machine or network, Naive Bayes, etc. In some examples, the model training circuitry 104A-E may compile and/or otherwise generate the ML model 124 as lightweight machine-learning models.

In general, implementing an ML/AI system involves two phases, a learning/training phase and an inference phase. In the learning/training phase, a training algorithm is used to train the ML model 124 to operate in accordance with patterns and/or associations based on, for example, the training data 122. In general, the ML model 124 include(s) internal parameters (e.g., a configuration image, configuration data, weights, etc.) that guide how input data is transformed into output data, such as through a series of nodes and connections within the ML model 124 to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of AI/ML model and/or the expected output. For example, the model training circuitry 104A-E may invoke supervised training to use inputs and corresponding expected (e.g., labeled) outputs to select parameters (e.g., by iterating over combinations of select parameters) for the ML model 124 that reduce model error. As used herein, “labeling” refers to an expected output of the machine learning model (e.g., a classification, an expected output value, a probability or likelihood, etc.). Alternatively, the model training circuitry 104A-E may invoke unsupervised training (e.g., used in deep learning, a subset of machine learning, etc.) that involves inferring patterns from inputs to select parameters for the ML model 124 (e.g., without the benefit of expected (e.g., labeled) outputs).

In some examples, the model training circuitry 104A-E trains the ML model 124 using unsupervised clustering of operating observables. However, the model training circuitry 104A-E may additionally or alternatively use any other training algorithm such as stochastic gradient descent, Simulated Annealing, Particle Swarm Optimization, Evolution Algorithms, Genetic Algorithms, Nonlinear Conjugate Gradient, etc.

In some examples, the model training circuitry 104A-E may train the ML model 124 until the level of error is no longer reducing. In some examples, the model training circuitry 104A-E may train the ML model 124 locally on the electronic system 102 and/or remotely at an external electronic system (e.g., one(s) of the external electronic systems 130) communicatively coupled to the electronic system 102. In some examples, the model training circuitry 104A-E trains the ML model 124 using hyperparameters that control how the learning is performed (e.g., a learning rate, a number of layers to be used in the machine learning model, etc.). In some examples, the model training circuitry 104A-E may use hyperparameters that control model performance and training speed such as the learning rate and regularization parameter(s). The model training circuitry 104A-E may select such hyperparameters by, for example, trial and error to reach an optimal model performance. In some examples, the model training circuitry 104A-E utilizes Bayesian hyperparameter optimization to determine an optimal and/or otherwise improved or more efficient network architecture to avoid model overfitting and improve the overall applicability of the ML model 124. Alternatively, the model training circuitry 104A-E may use any other type of optimization. In some examples, the model training circuitry 104A-E may perform re-training. The model training circuitry 104A-E may execute such re-training in response to override(s) by a user of the electronic system 102, a receipt of new training data, etc.

In some examples, the model training circuitry 104A-E facilitates the training of the ML model 124 using the training data 122. In some examples, the model training circuitry 104A-E utilizes the training data 122 that originates from locally generated data. In some examples, the model training circuitry 104A-E utilizes the training data 122 that originates from externally generated data, such as training data generated by one(s) of the external electronic systems 130. In some examples where supervised training is used, the model training circuitry 104A-E may label the training data 122 (e.g., label training data or portion(s) thereof with hard labels, soft labels, etc.). Labeling is applied to the training data by a user manually or by an automated data pre-processing system. In some examples, the model training circuitry 104A-E sub-divides the training data into a first portion of data for training the ML model 124, and a second portion of data for validating the ML model 124.

Once training is complete, the model training circuitry 104A-E may deploy the ML model 124 for use as an executable construct that processes an input and provides an output based on the network of nodes and connections defined in the ML model 124. The model training circuitry 104A-E may store the ML model 124 in the datastore 120. In some examples, the model training circuitry 104A-E may invoke the interface circuitry 114 to transmit the ML model 124 to one(s) of the external electronic systems 130. In some such examples, in response to transmitting the ML model 124 to the one(s) of the external electronic systems 130, the one(s) of the external electronic systems 130 may execute the ML model 124 to execute AI/ML workloads with at least one of improved efficiency or performance.

Once trained, the deployed ML model 124 may be operated in an inference phase to process data. In the inference phase, data to be analyzed (e.g., live data) is input to the ML model 124, and the ML model 124 execute(s) to create an output. This inference phase can be thought of as the AI “thinking” to generate the output based on what it learned from the training (e.g., by executing the ML model 124 to apply the learned patterns and/or associations to the live data). In some examples, input data undergoes pre-processing before being used as an input to the ML model 124. Moreover, in some examples, the output data may undergo post-processing after it is generated by the ML model 124 to transform the output into a useful result (e.g., a display of data, a detection and/or identification of an object, an instruction to be executed by a machine, etc.).

In some examples, output(s) of the deployed ML model 124 may be captured and provided as feedback. By analyzing the feedback, an accuracy of the deployed ML model 124 can be determined. If the feedback indicates that the accuracy of the deployed model is less than a threshold or other criterion, training of an updated model can be triggered using the feedback and an updated training data set, hyperparameters, etc., to generate an updated, deployed model.

In example operation, the model training circuitry 104A-E trains the ML model 124 based on the training data 122. For example, the third model training circuitry 104C of the first hardware accelerator 108 can retrieve the ML model 124 from the datastore 120, the external electronic systems 130 via the network 128, etc. In some examples, the third model training circuitry 104C can retrieve the training data 122, or portion(s) thereof, from the datastore 120, the external electronic systems 130 via the network 128, etc.

In example operation, the model training circuitry 104A-E trains the ML model 124 based on an example knowledge distillation technique. In some examples, the model training circuitry 104A-E can train the ML model 124 using a user-friendly, parameter-free, teacher-free self-feature distillation (Tf-SfD) technique. For example, the model training circuitry 104A-E can train the ML model 124 without a teacher machine learning model (e.g., teacher-free). In some examples, the model training circuitry 104A-E can train the ML model 124 by using features of the ML model 124 itself (e.g., self-feature). For example, the model training circuitry 104A-E can execute an inter-layer Tf-SfD operation by using features from a deeper layer of the ML model 124 to train a shallower layer of the ML model 124 (e.g., self-feature). In some examples, the model training circuitry 104A-E can execute an intra-layer Tf-SfD operation by using features from a first feature channel at a layer of the ML model 124 to train a second feature channel at the same layer of the ML model 124 (e.g., self-feature). In some examples, the model training circuitry 104A-E can train the ML model 124 without tuning parameter(s) associated with the ML model 124 via one or more inter-layer Tf-SfD operations, one or more intra-layer Tf-SfD operations, etc., and/or any combination(s) thereof (e.g., parameter-free). Advantageously, the model training circuitry 104A-E can output the ML model 124 as a lightweight, machine learning model with substantially similar accuracy to a dense, machine learning model.

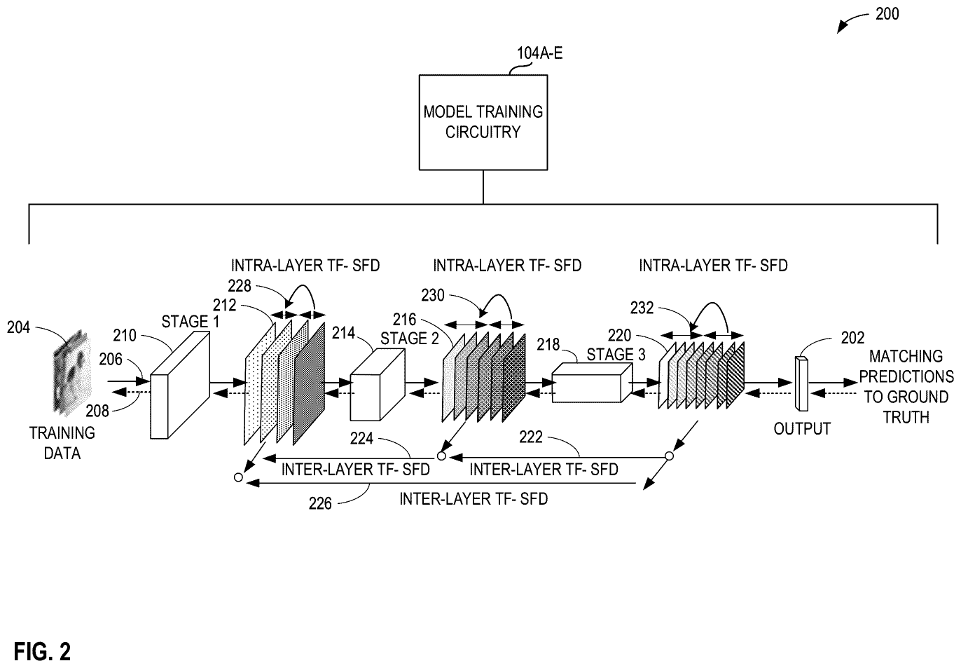

FIG. 2 is an illustration of an example machine learning model architecture 200. In some examples, the machine learning model architecture 200 can implement the ML model 124 of FIG. 1. For example, the model training circuitry 104A-E can train the machine learning model architecture 200 to generate, determine, and/or otherwise predict an example output 202 based on example training data 204 via example forward training processes 206 (identified by solid lines from left-to-right in FIG. 2) and example backwards training processes 208 (identified by dashed lines from right-to-left in FIG. 2). The machine learning model architecture 200 of the illustrated example is a neural network, such as a DNN. Alternatively, the machine learning model architecture 200 may be any other type of AI/ML model. The machine learning model architecture 200 of the illustrated example includes the training data 204, a first example stage 210 (identified by STAGE 1), a first example set of feature channels 212, a second example stage 214 (identified by STAGE 2), a second example set of feature channels 216, a third example stage 218 (identified by STAGE 3), a third example set of feature channels 220, and the output 202.

The output 202 of the illustrated example is an output channel or an output feature channel. For example, the output 202 can be a probability or likelihood that a portion of the training data 204 corresponds to a particular medical diagnosis (e.g., in a medical diagnosis application), object (e.g., in an object detection or machine vision application), etc. In the illustrated example, the training data 204 includes a plurality of images, pictures, etc. For example, the training data 204 can include images that have three channels, such as a red (R) channel, a green (G) green, and a blue (B) channel. Additionally and/or alternatively, the training data 204 may include any other type of data, such as video data, labels, etc., and/or may have any other number of channels.

The first stage 210, the second stage 214, and/or the third stage 218 is/are stage(s), layer(s), portion(s), segment(s), etc., of the machine learning model architecture 200. For example, the first stage 210, the second stage 214, and/or the third stage 218 can process input(s) (e.g., input channel(s), input feature channel(s), etc.) to generate output(s) (e.g., output channel(s), output feature channel(s), etc.). In some examples, the first stage 210, the second stage 214, and/or the third stage 218 can be a type of AI/ML operation, such as a convolution operation, a pooling operation (e.g., an average pooling operation, a maximum pooling operation, etc.), a fully-connected operation, etc.

In some examples, the first stage 210 can be a convolution stage or operation. For example, the first stage 210 can receive the training data 204, or portion(s) thereof, as input feature channels; execute convolution operation(s) on the input feature channels to generate the first set of feature channels 212 as output feature channels; and provide the first set of feature channels 212 to the second stage 214 as input feature channels. Alternatively, the first stage 210 can be any other type of AI/ML operation.

In some examples, the second stage 214 can be a pooling stage or operation. For example, the second stage 214 can receive the first set of feature channels 212 as input feature channels; execute pooling operation(s) on the input feature channels to generate the second set of feature channels 216 as output feature channels; and provide the second set of feature channels 216 to the third stage 218 as input feature channels. Alternatively, the second stage 214 can be any other type of AI/ML operation.

In some examples, the third stage 218 can be a fully-connected stage or operation. For example, the third stage 218 can receive the second set of feature channels 216 as input feature channels; execute fully-connected operation(s) on the input feature channels to generate the third set of feature channels 220 as output feature channels; and provide the third set of feature channels 220 to the output 202 as input feature channels. Alternatively, the third stage 218 can be any other type of AI/ML operation.

In some examples, the output 202 is an output stage that outputs a determination, a prediction, etc., that the training data 204, or portion(s) thereof, are associated with and/or otherwise correspond to a result of interest (e.g., a probability or likelihood that an object in the training data 204 is an animal, a traffic light, a vehicle, etc., in an object-recognition application). In some examples, the output 202 predicts an output to be compared to a ground truth for accuracy or error determination. For example, the model training circuitry 104A-E can compare the output 202 to a ground truth, such as an expected or pre-determined result, to determine an accuracy, an error, etc., of the machine learning model architecture 200. In some examples, the model training circuitry 104A-E compares the error to a threshold, such as an accuracy threshold, an error threshold, a machine learning model training threshold, etc.

In some examples, the model training circuitry 104A-E can complete training of the machine learning model architecture 200 after a fixed number of iterations that may be set before training. In some examples, the model training circuitry 104A-E can retrain or continue to train the machine learning model architecture 200 until the accuracy, the error, etc., is greater than the threshold and thereby satisfy the threshold. For example, the model training circuitry 104A-E can determine that the accuracy of the machine learning model architecture 200 is 0.55 (e.g., 55%); determine that the accuracy of 0.55 is less than an accuracy threshold of 0.75 (e.g., 75%); and determine that the accuracy of 0.55 does not satisfy the accuracy threshold of 0.75 because the accuracy of 0.55 is less than the accuracy threshold of 0.75.

In some examples, the model training circuitry 104A-E can compile and/or otherwise output the machine learning model architecture 200 as an executable construct (e.g., an executable binary file, a configuration image, etc.) for use in executing AI/ML workloads. For example, the model training circuitry 104A-E can store the machine learning model architecture 200 as the ML model 124 in the datastore 120 of FIG. 1 in response to a determination that the accuracy, the error, etc., associated with the machine learning model architecture 200 satisfies a respective threshold (e.g., an accuracy threshold, an error threshold, etc.).

Advantageously, the model training circuitry 104A-E can train the machine learning model architecture 200 without a teacher machine learning model by executing one or more example inter-layer Tf-SfD operations 222, 224, 226 and/or one or more intra-layer Tf-SfD operations 228, 230, 232. In the illustrated example, the model training circuitry 104A-E can execute one(s) of the inter-layer Tf-SfD operations 222, 224, 226 to cause shallower layer(s) to mimic and/or otherwise track deeper layer(s) of the machine learning model architecture 200. In the illustrated example, the model training circuitry 104A-E can execute one(s) of the intra-layer Tf-SfD operations 228, 230, 232 to cause feature channel(s) at a layer of the machine learning model architecture 200 that have non-salient features to mimic and/or otherwise track feature other feature channel(s) at the same layer that have salient features.

By way of example, the first stage 210 and/or the first set of feature channels 212 can correspond to a first layer of the machine learning model architecture 200. The second stage 214 and/or the second set of feature channels 216 can correspond to a second layer of the machine learning model architecture 200. The third stage 218 and/or the third set of feature channels 220 can correspond to a third layer of the machine learning model architecture 200. In the illustrated example, the first layer can be a shallow or shallower layer with respect to the second layer and the second layer can be a shallow or shallower layer with respect to the third layer. Conversely, the third layer can be a deep or deeper layer with respect to the second layer and the second layer can be a deep or deeper layer with respect to the first layer.

In example operation, the inter-layer Tf-SfD operations 222, 224, 226 can squeeze and/or otherwise transfer feature knowledge in deeper layers to the shallow layers by a feature mimicking process as described herein. For example, the model training circuitry 104A-E can provide feature knowledge from a deeper layer of the machine learning model architecture 200, such as the third set of feature channels 220, to a shallower layer of the machine learning model architecture 200, such as the second set of feature channels 216, by way of the first inter-layer Tf-SfD operation 222. In some examples, the model training circuitry 104A-E can provide feature knowledge from a deeper layer of the machine learning model architecture 200, such as the second set of feature channels 216, to a shallower layer of the machine learning model architecture 200, such as the first set of feature channels 212, by way of the second inter-layer Tf-SfD operation 224. In some examples, the model training circuitry 104A-E can provide feature knowledge from a deeper layer of the machine learning model architecture 200, such as the third set of feature channels 220, to a shallower layer of the machine learning model architecture 200, such as the first set of feature channels 212, by way of the third inter-layer Tf-SfD operation 226.

In example operation, the inter-layer Tf-SfD operations 222, 224, 226 can squeeze and/or otherwise transfer feature knowledge within a layer by a feature mimicking process as described herein. For example, the model training circuitry 104A-E can divide feature channels, such as the first set of feature channels 212, into two or more groups, sets (e.g., subsets), etc., (e.g., one or more groups or subsets with salient feature channels, and the other(s) with non-salient feature channels) and cause the group(s) with non-salient feature channels to mimic the other group(s) with salient feature channels by way of the first intra-layer Tf-SfD operation 228. In some examples, the model training circuitry 104A-E can divide feature channels, such as the second set of feature channels 216, into two or more groups, sets, etc., and cause the group(s) with non-salient feature channels to mimic the other group(s) with salient feature channels by way of the second intra-layer Tf-SfD operation 230. In some examples, the model training circuitry 104A-E can divide feature channels, such as the third set of feature channels 220, into two or more groups, sets, etc., and cause the group(s) with non-salient feature channels to mimic the other group(s) with salient feature channels by way of the third intra-layer Tf-SfD operation 232.

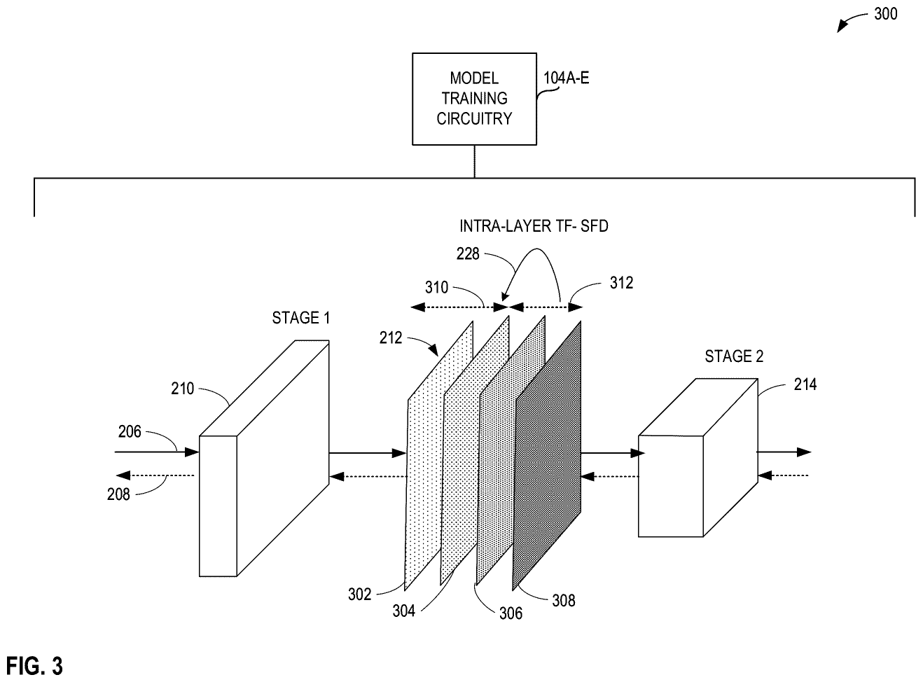

FIG. 3 is a first example portion 300 of the example machine learning model architecture 200 of FIG. 2. The first portion 300 includes the first stage 210, the first set of feature channels 212, and the second stage 214 of FIG. 2 to exemplify the first intra-layer Tf-SfD operation 228 of FIG. 2. For example, the model training circuitry 104A-E can carry out, perform, and/or otherwise cause execution of the first intra-layer Tf-SfD operation 228.

In some examples, training of a DNN, which may be implemented by the machine learning model architecture 200, can be based on optimizing and/or otherwise reducing a cross-entropy loss function described below in the example of Equation (1):

$${LOSS}_{CE} ( X , S ) , \qquad Equation ( 1 )$$

In the example of Equation (1) above, X can be the training dataset and S can be the target student machine learning model that is to be trained and/or deployed for practical, real AI/ML application(s). For example, X can be implemented by the training data 122 of FIG. 1, or portion(s) thereof. In some examples, S can be implemented by the ML model 124 of FIG. 1 and/or the machine learning model architecture 200 of FIG. 2. In some examples, S can be a machine learning model that has L layers and F_{S} batched output features defined below in the example of Equation (2) below. In the example of Equation (2) below, F_{S} can be the batched output features at the l^{th} layer of S.

$${F}_{S} = \{ {F}_{{S}_{l}} \vert 1 \leq l \leq L \} , \qquad Equation ( 2 )$$

To effectuate a teacher-free self-feature knowledge distillation operation, such as the first intra-layer Tf-SfD operation 228, the model training circuitry 104A-E can train a machine learning model by optimizing and/or otherwise reducing a value of a loss function based on the example of Equation (1) above as described below in the example of Equation (3) below:

$${LOSS}_{CE} ( X , S ) + {LOSS}_{intra} ( X , {F}_{S} ) + {LOSS}_{inter} ( X , {F}_{S} ) , \qquad Equation ( 3 )$$

In the example of Equation (3) above, two parameter-free loss terms LOSSᵢₙₜᵣₐ(X, F_{S}) and LOSSᵢₙₜₑᵣ(X, F_{S}) are added to the example of Equation (1) above to enable intra-layer Tf-SfD operations (e.g., the intra-layer Tf-SfD operations 228, 230, 232 of FIG. 2) and inter-layer Tf-SfD operations (e.g., the inter-layer Tf-SfD operations 222, 224, 226 of FIG. 2) to achieve boosted training performance of a machine learning model, such as the ML model 124 of FIG. 1 and/or the machine learning model architecture 200 of FIG. 2.

In some examples, output features of a machine learning model, such as the machine learning model architecture 200, are not equally important for a particular layer of the machine learning model. For example, within a layer of the machine learning model, some features of the layer are more salient and/or useful than other feature(s) of the layer. Advantageously, the intra-layer Tf-SfD operations 228, 230, 232 can utilize the salient features from a layer to assist the learning of the other feature(s) (e.g., the non-salient feature(s)) at the same layer. In the context of AI/ML, saliency of a feature refers to whether the feature is noticeable or important with respect to other feature(s). In some examples, a feature that corresponds to and/or otherwise is represented by a feature channel can have a level of saliency based on output values of the feature channel. For example, a first sum of first output values of a first feature channel that is greater than a second sum of second output values of a second feature channel can indicate that a first feature represented by the first feature channel is more salient than a second feature represented by the second feature channel. In some examples, the normalization weights that are calculated for normalizing the different feature channels can be utilized to identify salient versus non-salient features. For example, a first normalization weight can be associated with a first feature and a second normalization weight can be associated with a second feature. In some examples, the first feature can be more salient than the second feature based on the first normalization weight being greater than (or in other examples less than) the second normalization weight

In example operation, the model training circuitry 104A-E can divide the first set of feature channels 212 into two or more collections, groups, subsets, etc., based on saliency. For example, the first intra-layer Tf-SfD operation 228 can divide the first set of feature channels 212 into two or more disjoint groups having the same number of channels (e.g., the same channel size) in which a first group F_{S}_{ᵢ}¹ has salient features and a second group F_{S}_{ᵢ}² has non-salient features. Advantageously, the model training circuitry 104A-E can improve training of the machine learning model architecture 200 by causing the group with the non-salient features to mimic and/or otherwise track the group with the salient features at the same layer via the first intra-layer Tf-SfD operation 228. For example, the model training circuitry 104A-E can execute the first intra-layer Tf-SfD operation 228 based on the example of Equation (4) below:

$${Loss}_{intra} ( X , {F}_{S} ) = \frac{1}{L} {\sum }_{i = 1}^{L} {‖ {F}_{{S}_{i}}^{1} - {F}_{{S}_{i}}^{2} ‖}_{2}^{2} , \qquad Equation ( 4 )$$

In the example of Equation (4) above, L is the number of layers on which to perform an intra-layer Tf-SfD operation (e.g., the first intra-layer Tf-SfD operation 228), i is an index value, and F_{S}_{ᵢ}¹ and F_{S}_{ᵢ}² are first batched output features at a first feature channel at a layer corresponding to the index i and second batched features at a second feature channel at the layer corresponding to the index i, respectively. In the example of Equation (4) above, Lossᵢₙₜᵣₐ(X, F_{S}) corresponds to the loss function Lossᵢₙₜᵣₐ(X, F_{S}) in the example of Equation (3) above.

In the illustrated example, the first set of feature channels 212 include a first example feature channel 302, a second example feature channel 304, a third example feature channel 306, and a fourth example feature channel 308. In example operation, the model training circuitry 104A-E can determine a first sum of first output values of the first feature channel 302, a second sum of second output values of the second feature channel 304, a third sum of third output values of the third feature channel 306, and a fourth sum of fourth output values of the fourth feature channel 308. For example, the first sum can be a sum of absolute values of the first output values. The second sum can be a sum of absolute values of the second output values. The third sum can be a sum of absolute values of the third output values. The fourth sum can be a sum of absolute values of the fourth output values.

In example operation, the model training circuitry 104A-E can group the first feature channel 302 and the second feature channel 304 into a first example group 310 of the first set of feature channels 212 and group the third feature channel 306 and the fourth feature channel 308 into a second example group 312 of the first set of feature channels 212. For example, the model training circuitry 104A-E can group the first feature channel 302 into the first group 310 based on the first sum of the first output values of the first feature channel 302 being less than the third sum and/or the fourth sum. In some examples, the model training circuitry 104A-E can group the second feature channel 304 into the first group 310 based on the first sum of the second output values of the second feature channel 304 being less than the third sum and/or the fourth sum. Conversely, the model training circuitry 104A-E can group the third feature channel 306 into the second group 312 based on the third sum of the third output values of the third feature channel 306 being greater than the first sum and/or the second sum. In some examples, the model training circuitry 104A-E can group the fourth feature channel 308 into the second group 312 based on the fourth sum of the fourth output values of the fourth feature channel 308 being greater than the first sum and/or the second sum.

In example operation, in response to grouping the first set of feature channels 212 into the first group 310 and the second group 312 based on saliency associated with the first set of feature channels 212, the model training circuitry 104A-E can compare the first group 310 to the second group 312. For example, the model training circuitry 104A-E can compare the first group 310 and the second group 312 based on differences (e.g., an absolute value of differences) between the first group 310, or portion(s) thereof, and the second group 312, or portion(s) thereof, by way of the example of Equation (4) above. In some examples, the model training circuitry 104A-E can determine differences between one of the first group 310 that has the least saliency (e.g., a feature channel with the smallest sum of absolute output values) and one of the second group 312 that has the most saliency (e.g., a feature channel with the greatest sum of absolute output values) to ensure that the least important feature channel with respect to saliency mimics the most important feature channel with respect to saliency to improve training accuracy, performance, and/or efficiency. In some examples, the model training circuitry 104A-E can determine differences between one of the first group 310 that has the second-to-least saliency and one of the second group 312 that that has the second-to-most saliency, and so forth until differences are determined for ones of the first group 310 and ones of the second group 312.

In example operation, the model training circuitry 104A-E can determine an error value of a loss function, such as Lossᵢₙₜᵣₐ(X, F_{S}) of the example of Equation (4) above, based on the comparison of the first group 310 and the second group 312. The model training circuitry 104A-E can adjust parameters associated with the first stage 210 and/or, more generally, the machine learning model architecture 200, based on the comparison of the first group 310 and the second group 312. For example, the model training circuitry 104A-E can adjust one or more first weight values of a convolution filter of the first stage 210 to one or more second weight values to cause the first output values of the first feature channel 302 to track the third output values of the third feature channel 306 and/or the fourth output values of the fourth feature channel 308. In some examples, the model training circuitry 104A-E can adjust one or more first weight values of a convolution filter of the first stage 210 to one or more second weight values to cause the second output values of the second feature channel 304 to track the third output values of the third feature channel 306 and/or the fourth output values of the fourth feature channel 308. Advantageously, by causing feature channels with non-salient features, such as the first feature channel 302 and/or the second feature channel 304, to mimic and/or otherwise track feature channels with salient features, such as the third feature channel 306 and/or the fourth feature channel 308, the machine learning model architecture 200 can be trained with improved accuracy and efficiency without the need for a teacher machine learning model as in conventional knowledge distillation techniques.

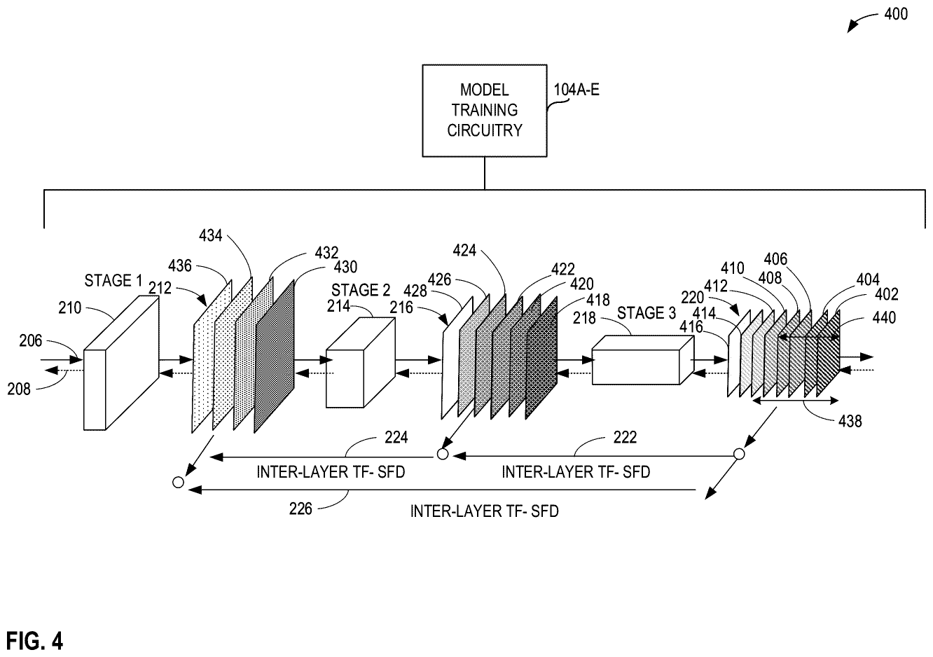

FIG. 4 is a second example portion 400 of the example machine learning model architecture 200 of FIG. 2. The second portion 400 includes the first set of feature channels 212, the second stage 214, the second set of feature channels 216, the third stage 218, and the third set of feature channels 220 of FIG. 2 to exemplify the inter-layer Tf-SfD operations 222, 224, 226 of FIG. 2. For example, the model training circuitry 104A-E can carry out, perform, and/or otherwise cause execution of one(s) of the inter-layer Tf-SfD operation 222, 224, 226.

The third set of feature channels 220 include a fifth example feature channel 402, a sixth example feature channel 404, a seventh example feature channel 406, an eighth example feature channel 408, a ninth example feature channel 410, a tenth example feature channel 412, an eleventh example feature channel 414, and a twelfth example feature channel 416. The second set of feature channels 216 include a thirteenth example feature channel 418, a fourteenth example feature channel 420, a fifteenth example feature channel 422, a sixteenth example feature channel 424, a seventeenth example feature channel 426, and an eighteenth example feature channel 428. The first set of feature channels 212 include a nineteenth example feature channel 430, a twentieth example feature channel 432, a twenty-first example feature channel 434, and a twenty-second example feature channel 436.

In some examples, output features of a machine learning model, such as the machine learning model architecture 200, are not equally important within the machine learning model. For example, features from a deep layer of the machine learning model are more discriminative and/or otherwise useful with respect to an application (e.g., a visual recognition task or workload) compared to features from a shallower layer. Advantageously, the inter-layer Tf-SfD operations 222, 224, 226 can utilize informative features (e.g., salient features) from deep layers of the machine learning model architecture 200 to assist and/or otherwise improve the feature learnings at shallower layers of the machine learning model architecture 200. For example, the model training circuitry 104A-E can execute the inter-layer Tf-SfD operations 222, 224, 226 to force and/or otherwise cause shallow features to mimic deep features.

In some examples, the model training circuitry 104A-E can execute the first inter-layer Tf-SfD operation 222 based on the example of Equation (5) below:

$${Loss}_{inter} ( X , {F}_{S} ) = \frac{1}{N} {\sum }_{i = 1}^{L - 1} {\sum }_{j = 2}^{L} {‖ Proj ( {F}_{{S}_{j}} ) - {F}_{{S}_{i}} ‖}_{2}^{2} , \qquad Equation ( 5 )$$

In the example of Equation (5) above, N is the number of layer pairs to perform an inter-layer Tf-SfD operation, such as one of the inter-layer Tf-SfD operations 222, 224, 226. In the example of Equation (5) above, Lossᵢₙₜₑᵣ(X, F_{S}) corresponds to the loss function Lossᵢₙₜₑᵣ(X, F_{S}) in the example of Equation (3) above. In the example of Equation (5) above, Proj denotes a feature projection process at deeper layers to map the deep features to have the same dimension to the features at shallow layers. For example, the model training circuitry 104A-E can select deep-shallow pairs to carry out the inter-layer Tf-SfD operations 222, 224, 226. For example, the model training circuitry 104A-E can select the third set of feature channels 220 as a deep layer to teach the second set of feature channels 216 as a shallow layer to perform the first inter-layer Tf-SfD operation 222. In some examples, the model training circuitry 104A-E can select the second set of feature channels 216 as a deep layer to teach the first set of feature channels 212 as a shallow layer to perform the second inter-layer Tf-SfD operation 224. In some examples, the model training circuitry 104A-E can select the third set of feature channels 220 as a deep layer to teach the first set of feature channels 212 as a shallow layer to perform the third inter-layer Tf-SfD operation 226.

In some examples, for a deep-shallow layer pair in an inter-layer Tf-SfD operation, the deep layer and the shallow layer can have different numbers of feature channels with different spatial sizes (e.g., different heights and/or widths). In some examples, the model training circuitry 104A-E can select deep feature channels based on sums of absolute output values of a feature channel to reconcile the deep layer having a different number of feature channels. In some examples, the model training circuitry 104A-E can down sample a shallow layer to achieve spatial feature size alignment. For example, the model training circuitry 104A-E can down sample the shallow layer by way of a pooling operation (e.g., an average pooling operation, a maximum pooling operation, etc.), changing a stride length associated with an AI/ML operation (e.g., changing a stride length of a convolution operation), etc.

In some examples, the model training circuitry 104A-E can reconcile different numbers of feature channels in a deep-shallow layer pair by identifying one(s) of feature channels in the deep layer that have increasingly salient and/or otherwise informative features. By way of example, the model training circuitry 104A-E can select a deep-shallow layer pair to be the third set of feature channels 220 as the deep layer and the second set of feature channels 216 as the shallow layer. In the illustrated example, the third set of feature channels 220 include eight feature channels and the second set of feature channels 216 include six feature channels. The model training circuitry 104A-E can determine to reconcile the difference in the number of feature channels (e.g., six feature channels versus eight feature channels) by identifying the top six of the third set of feature channels 220 with respect to saliency (e.g., identify six of the third set of feature channels 220 that have the most saliency) and associating the top six of the third set of feature channels 220 with the six ones of the second set of feature channels 216.

In example operation, the model training circuitry 104A-E can identify the top six of the third set of feature channels 220 with respect to and/or otherwise based on saliency by determining sums of absolute values of output values of the third set of feature channels 220. For example, the model training circuitry 104A-E can determine a first sum of absolute values of first output values of the fifth feature channel 402, a second sum of absolute values of second output values of the sixth feature channel 404, etc. The model training circuitry 104A-E can select and/or otherwise identify the top six of the third set of feature channels 220 based on their respective sums. For example, the model training circuitry 104A-E can identify the fifth feature channel 402, the sixth feature channel 404, the seventh feature channel 406, the eighth feature channel 408, the ninth feature channel 410, and the tenth feature channel 412 of the third set of feature channels 220 as the top six based on their respective sums being greater than a respective sum of the eleventh feature channel 414 and/or the twelfth feature channel 416.

The model training circuitry 104A-E can select the six ones of the third set of feature channels 220 that have the highest sums of absolute values of output values to be included in a first example group 438. For example, the six ones (e.g., the fifth feature channel 402, the sixth feature channel 404, etc.) of the third set of feature channels 220 to be included in the first group 438 can have a greater level of saliency with respect to the two non-selected feature channels, such as the eleventh feature channel 414 and the twelfth feature channel 416 of the third set of feature channels 220 that are not to be included in the first group 438. Additionally and/or alternatively, the model training circuitry 104A-E can select one(s) of the third set of feature channels 220 to be included in the first group 438 via any other technique (e.g., a saliency determination technique). For example, the model training circuitry 104A-E can select one(s) of the third set of feature channels 220 to be included in the first group 438 based on normalization weights (e.g., values of normalization weights) associated with the one(s) of the third set of feature channels 220.

In example operation, in response to selecting ones of the third set of feature channels 220 to be included in the first group 438, the model training circuitry 104A-E can execute the first inter-layer Tf-SfD operation 222 by causing the second set of feature channels 216 to mimic and/or otherwise be correlated to the first group 438 of the third set of feature channels 220. In some examples, the model training circuitry 104A-E can pair a most salient feature channel of the first group 438 (e.g., the fifth feature channel 402) with a least salient feature channel in the second set of feature channels 216 (e.g., the eighteenth feature channel 428), a next-most salient feature channel of the first group 438 (e.g., the sixth feature channel 404) with a next-least salient feature channel in the second set of feature channels 216 (e.g., the seventeenth feature channel 426), and so forth during the first inter-layer Tf-SfD operation 222.

In some examples, the model training circuitry 104A-E can adjust (e.g., iteratively adjust) first parameters of the second stage 214 and/or second parameters of the third stage 218 to optimize the loss function of the example of Equation (5) above. For example, the model training circuitry 104A-E can select first parameter values (e.g., first weight values of a convolution filter, a first stride length, etc., and/or any combination(s) thereof) of the second stage 214 and second parameter values (e.g., second weight values of a convolution filter, a second stride length, etc.) of the third stage 218. The model training circuitry 104A-E can execute (e.g., iteratively execute) the machine learning model architecture 200 in a forward direction (e.g., from shallow to deep) by way of the forward training processes 206 and/or a reverse direction (e.g., from deep to shallow) by way of the reverse training processes 208 to optimize the loss function described above in connection with the example of Equation (5).

By way of another example, the model training circuitry 104A-E can select a deep-shallow layer pair to be the third set of feature channels 220 as the deep layer and the first set of feature channels 212 as the shallow layer to carry out the third inter-layer Tf-SfD operation 226. Additionally and/or alternatively, the model training circuitry 104A-E can select a deep-shallow layer pair to be the second set of feature channels 216 as the deep layer and the first set of feature channels 212 as the shallow layer to carry out the second inter-layer Tf-SfD operation 224.

In the illustrated example, the third set of feature channels 220 include eight feature channels and the first set of feature channels 212 include four feature channels. The model training circuitry 104A-E can determine to reconcile the difference in the number of feature channels (e.g., four feature channels with respect to eight feature channels) by identifying the top four of the third set of feature channels 220 with respect to saliency (e.g., identify four of the third set of feature channels 220 that have the most saliency) and associating the top four of the third set of feature channels 220 with the four ones of the second set of feature channels 216.

In example operation, the model training circuitry 104A-E can identify the top four of the third set of feature channels 220 with respect to saliency by determining sums of absolute values of output values of the third set of feature channels 220. For example, the model training circuitry 104A-E can determine a first sum of absolute values of first output values of the fifth feature channel 402, a second sum of absolute values of second output values of the sixth feature channel 404, etc. The model training circuitry 104A-E can select the four ones of the third set of feature channels 220 that have the highest sums of absolute values of output values to be included in a second example group 440. For example, the four ones of the third set of feature channels 220 to be included in the second group 440 can have an increased level of saliency with respect to the four other ones of the third set of feature channels 220 that are not to be included in the second group 440. For example, the model training circuitry 104A-E can select the fifth feature channel 402, the sixth feature channel 404, the seventh feature channel 406, and the eighth feature channel 408 to be included in the second group 440 because they have respective sums of absolute values of output values that are greater than the respective sums of absolute values of output values of the ninth feature channel 410, the tenth feature channel 412, the eleventh feature channel 414, and/or the twelfth feature channel 416. Additionally and/or alternatively, the model training circuitry 104A-E can select one(s) of the third set of feature channels 220 to be included in the second group 440 by way of any other technique (e.g., a saliency determination technique).

In example operation, in response to selecting ones of the third set of feature channels 220 to be included in the second group 440, the model training circuitry 104A-E can execute the third inter-layer Tf-SfD operation 226 by causing the first set of feature channels 212 to mimic and/or otherwise be correlated to the second group 440 of the third set of feature channels 220. In some examples, the model training circuitry 104A-E can pair a most salient feature channel of the second group 440 (e.g., the fifth feature channel 402) with a least salient feature channel in the first set of feature channels 212 (e.g., the twenty-second feature channel 436), a next-most salient feature channel of the second group 440 (e.g., the seventh feature channel 406) with a next-least salient feature channel in the first set of feature channels 212 (e.g., the twenty-first feature channel 434), and so forth during the third inter-layer Tf-SfD operation 226.

In some examples, the model training circuitry 104A-E can adjust (e.g., iteratively adjust) first parameters of the first stage 210 and/or second parameters of the second stage 214 to optimize the loss function of the example of Equation (5) above. For example, the model training circuitry 104A-E can select first parameter values (e.g., first weight values of a convolution filter, a first stride length, etc., and/or any combination(s) thereof) of the first stage 210 and second parameter values (e.g., second weight values of a convolution filter, a second stride length, etc.) of the second stage 214. The model training circuitry 104A-E can execute (e.g., iteratively execute) the machine learning model architecture 200 in a forward direction (e.g., from shallow to deep) by way of the forward training processes 206 and/or a reverse direction (e.g., from deep to shallow) by way of the reverse training processes 208 to optimize the loss function described above in connection with the example of Equation (5).

In some examples, the model training circuitry 104A-E can reconcile different spatial sizes of feature channels in a deep-shallow layer pair by down sampling the shallow layer to match the size of the deep layer. By way of example, the model training circuitry 104A-E can select the third set of feature channels 220 as a deep layer and the first set of feature channels 212 as a shallow layer to perform the third inter-layer Tf-SfD operation 226. For example, ones of the first set of feature channels 212 can have a first size (e.g., a first height or length, a first width, etc.) and ones of the third set of feature channels 220 can have a second size (e.g., a second height or length, a second width, etc.). In example operation, the model training circuitry 104A-E can down sample the nineteenth feature channel 430, the twentieth feature channel 432, the twenty-first feature channel 434, and/or the twenty-second feature channel 436 from the first size to the second size by way of down sampling operation(s). For example, the down sampling operation can implement the Proj feature projection process of the example of Equation (5) above). In some examples, the down sampling operation can be an AI/ML operation such as a pooling operation (e.g., an average pooling operation, a maximum pooling operation, etc.). In some examples, the down sampling operation can be a change in a configuration of an AI/ML operation, such as a change in a stride length (e.g., an increase in a stride length) during a convolution operation of the first stage 210.

By way of another example, the model training circuitry 104A-E can select the third set of feature channels 220 as a deep layer and the second set of feature channels 216 as a shallow layer to perform the first inter-layer Tf-SfD operation 222. For example, ones of the second set of feature channels 216 can have a first size (e.g., a first height or length, a first width, etc.) and ones of the third set of feature channels 220 can have a second size (e.g., a second height or length, a second width, etc.). In example operation, the model training circuitry 104A-E can down sample the thirteenth feature channel 418, the fourteenth feature channel 420, the fifteenth feature channel 422, the sixteenth feature channel 424, the seventeenth feature channel 426, and/or the eighteenth feature channel 428 from the first size to the second size by way of the aforementioned down sampling operation(s). For example, the down sampling operation can be a change in a configuration of an AI/ML operation, such as a change in a stride length (e.g., an increase in a stride length) during a convolution operation of the second stage 214.

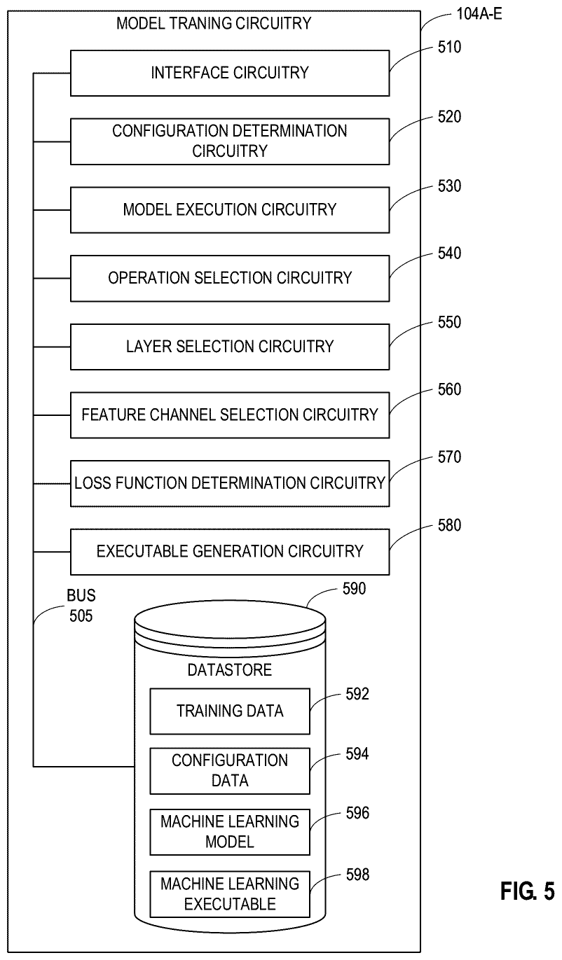

FIG. 5 is a block diagram of an example implementation of the model training circuitry 104A-E to train a teacher-free machine learning model with improved accuracy, improved performance, and/or reduced computational costs (e.g., a quantity of hardware, software, and/or firmware resources of the electronic system 102, a duration of execution by the quantity of the hardware, the software, and/or the firmware resources, etc.). The model training circuitry 104A-E of FIGS. 1, 2, 3, 4, and/or 5 may be instantiated (e.g., creating an instance of, bring into being for any length of time, materialize, implement, etc.) by processor circuitry such as a central processing unit executing instructions. Additionally or alternatively, the model training circuitry 104A-E of FIGS. 1, 2, 3, 4, and/or 5 may be instantiated (e.g., creating an instance of, bring into being for any length of time, materialize, implement, etc.) by an ASIC or an FPGA structured to perform operations corresponding to the instructions. It should be understood that some or all of the model training circuitry 104A-E of FIGS. 1, 2, 3, 4, and/or 5 may, thus, be instantiated at the same or different times. Some or all of the model training circuitry 104A-E of FIGS. 1, 2, 3, 4, and/or 5 may be instantiated, for example, in one or more threads executing concurrently on hardware and/or in series on hardware. Moreover, in some examples, some or all of the model training circuitry 104A-E of FIGS. 1, 2, 3, 4, and/or 5 may be implemented by one or more virtual machines and/or containers executing on the microprocessor.

The model training circuitry 104A-E of FIG. 5 includes an example bus 505, example interface circuitry 510, example configuration determination circuitry 520, example model execution circuitry 530, example operation selection circuitry 540, example layer selection circuitry 550, example feature channel selection circuitry 560, example loss function determination circuitry 570, example executable generation circuitry 580, and an example datastore 590. The datastore 590 of the illustrated example includes example training data 592, example configuration data 594, an example machine learning model 596, and an example machine learning executable 598. In the illustrated example of FIG. 5, the interface circuitry 510, the configuration determination circuitry 520, the model execution circuitry 530, the operation selection circuitry 540, the layer selection circuitry 550, the feature channel selection circuitry 560, the loss function determination circuitry 570, the executable generation circuitry 580, and the datastore 590 are in communication with the bus 505. In some examples, the bus 505 can be implemented with bus circuitry, bus software, and/or bus firmware. For example, the bus 505 can be implemented by at least one of an Inter-Integrated Circuit (I2C) bus, a Serial Peripheral Interface (SPI) bus, a Peripheral Component Interconnect (PCI) bus, or a Peripheral Component Interconnect Express (PCIe or PCIE) bus. Additionally or alternatively, the bus 505 can be implemented by any other type of computing or electrical bus.

The model training circuitry 104A-E of FIG. 5 includes the interface circuitry 510 to receive and/or transmit data. In some examples, the interface circuitry 510 can receive data, such as the training data 122, the ML model 124, etc., from the datastore 120 (e.g., by way of the bus 116). In some examples, the interface circuitry 510 can receive data, such as the training data 122, the ML model 124, etc., from one(s) of the external electronic systems 130 via the network 128. In some examples, the interface circuitry 510 can receive data, such as a change in a configuration (e.g., the configuration data 594) of the ML model 124, via the user interface 126.

The model training circuitry 104A-E of FIG. 5 includes the configuration determination circuitry 520 to identify and/or determine a configuration (e.g., the configuration data 594) of an AI/ML model, such as the ML model 124, the machine learning model architecture 200 of FIGS. 2-4, etc. In some examples, the configuration determination circuitry 520 can select a type of AI/ML operation, such as a convolution operation, a pooling operation, etc., to be implemented by one(s) of the stages 210, 214, 218 of FIGS. 2-4. In some examples, the configuration determination circuitry 520 can adjust a configuration of an AI/ML operation, such as a stride length to be carried out by one(s) of the stages 210, 214, 218. In some examples, the configuration determination circuitry 520 can adjust value(s) of a layer of an AI/ML model, such as activation values, weight values, etc., associated with one(s) of the stages 210, 214, 218. For example, the configuration determination circuitry 520 can adjust parameters of an AI/ML model based on comparisons carried out in connection with the inter-layer Tf-SfD operations 222, 224, 226 and/or the intra-layer Tf-SfD operations 228, 230, 232 as described herein. In some examples, the configuration data 594 can include a topology of the AI/ML model, which can include a number and/or type of stages or AI/ML operations, a number of feature channels and/or corresponding size, weight values, activation values, etc., and/or any other combination(s) thereof.

The model training circuitry 104A-E of FIG. 5 includes the model execution circuitry 530 to execute and/or otherwise cause or invoke execution of an AI/ML model, such as the ML model 124 of FIG. 1, the machine learning model architecture 200 of FIGS. 2-4, etc. In some examples, the machine learning model 596 can be implemented by the ML model 124 of FIG. 1 and/or the machine learning model architecture 200 of FIGS. 2-4. In some examples, the model execution circuitry 530 can execute the machine learning model architecture 200 in a training phase for one or more iterations (e.g., training iterations) by way of the forward training processes 206 and/or the backwards training processes 208 using the training data 592. For example, the model execution circuitry 530 can generate and/or otherwise output values of one(s) of the feature channels 212, 216, 220 by executing respective one(s) of the stages 210, 214, 218 on portion(s) of the training data 592. In some examples, the training data 592 can be implemented by the training data 122 of FIG. 1 and/or the training data 204 of FIGS. 2. In some examples, the model execution circuitry 530 can execute the machine learning model architecture 200 in an inference phase by generating an output, such as the output 202 of FIGS. 2-4, based on input data to carry out an AI/ML workload.

In some examples, the model execution circuitry 530 down samples a feature channel to facilitate an inter-layer Tf-SfD operation, such as one(s) of the inter-layer Tf-SfD operations 222, 224, 226. For example, the model execution circuitry 530 can execute the first stage 210 to down sample one(s) of the first set of feature channels 212 from a first size to a second size. In some examples, the first stage 210 can implement a convolution operation, and the model execution circuitry 530 can down sample one(s) of the first set of feature channels 212 by changing a stride length of the convolution operation. In some examples, the model execution circuitry 530 can down sample one(s) of the first set of feature channels 212 by performing a pooling operation (e.g., an average pooling operation, a maximum pooling operation, etc.), which can implement the first stage 210.

The model training circuitry 104A-E of FIG. 5 includes the operation selection circuitry 540 to select a type of operation, such as a Tf-SfD operation, to be executed. In some examples, the operation selection circuitry 540 can select an inter-layer Tf-SfD operation, such as the first inter-layer Tf-SfD operation 222, to be carried out in connection with the second set of feature channels 216 and the third set of feature channels. In some examples, the operation selection circuitry 540 can select an intra-layer Tf-SfD operation, such as the first intra-layer Tf-SfD operation 228, to be carried out on the first set of feature channels 212. In some examples, the operation selection circuitry 540 can select any other combination of inter-layer and/or intra-layer Tf-SfD operation to be performed in connection with an AI/ML model, such as the machine learning model architecture 200 of FIGS. 2-4.

The model training circuitry 104A-E of FIG. 5 includes the layer selection circuitry 550 to select a layer of an AI/ML model. In some examples, the layer selection circuitry 550 can select a layer for determination of a loss function as described herein. For example, the layer selection circuitry 550 can select a first layer of an AI/ML model, such as the first stage 210 and/or the first set of feature channels 212, for execution of the first intra-layer Tf-SfD operation 228. In some examples, the layer selection circuitry 550 can select at least a second layer and a third layer of an AI/ML model, such as (i) the second stage 214 and/or the second set of feature channels 216 and (ii) the third stage 218 and/or the third set of feature channels 220, for execution of the first inter-layer Tf-SfD operation 222. In some examples, the layer selection circuitry 550 can determine to make another selection of layer(s) of the AI/ML model.

The model training circuitry 104A-E of FIG. 5 includes the feature channel selection circuitry 560 to select feature channel(s) for execution of an inter-layer Tf-SfD operation and/or an intra-layer Tf-SfD operation. In some examples, the feature channel selection circuitry 560 selects the feature channel(s) based on respective sum(s) of the feature channel(s).

By way of example, the operation selection circuitry 540 can select the first intra-layer Tf-SfD operation 228 to be completed, and the layer selection circuitry 550 can select the first stage 210 and/or the first set of feature channels 212 for the first intra-layer Tf-SfD operation 228. In some examples, the feature channel selection circuitry 560 can determine a first sum (or a first partial sum) of the first output values of the first feature channel 302, a second sum (or a second partial sum) of the second output values of the second feature channel 304, a third sum (or a third partial sum) of the third output values of the third feature channel 306, and/or a fourth sum (or a fourth partial sum) of the fourth feature channel 308. In some examples, the feature channel selection circuitry 560 can group the first feature channel 302 and/or the second feature channel 304 into a first group of the first set of feature channels 212 based on the first sum and the second sum being less than the third sum and the fourth sum. In some examples, the feature channel selection circuitry 560 can group the third feature channel 306 and/or the fourth feature channel 308 into a second group of the first set of feature channels 212 based on the third sum and the fourth sum being greater than the first sum and the second sum.

In some examples, the feature channel selection circuitry 560 can determine that the third feature channel 306 has a greater number of salient features than the first feature channel 302 and the second feature channel 304 based on the third sum being greater than the first sum and the second sum. In some examples, the feature channel selection circuitry 560 can determine that the fourth feature channel 308 has a greater number of salient features than the first feature channel 302 and the second feature channel 304 based on the fourth sum being greater than the first sum and the second sum. In some examples, the feature channel selection circuitry 560 can determine that the fourth feature channel 308 has a greater number of salient features than the third feature channel 306 based on the fourth sum being greater than the third sum. In some examples, the feature channel selection circuitry 560 can determine that the third feature channel 306 and the fourth feature channel 308 are more important than the first feature channel 302 and the second feature channel 304 for training purposes, loss optimization purposes, etc., because the third feature channel 306 and the fourth feature channel 308 have a greater number of salient features than the first feature channel 302 and the second feature channel 304.

By way of another example, the operation selection circuitry 540 can select the first inter-layer Tf-SfD operation 222 to be executed, and the layer selection circuitry 550 can select the second stage 214, the second set of feature channels 216, the third stage 218, and/or the third set of feature channels 220 for the first inter-layer Tf-SfD operation 222. In some examples, the feature channel selection circuitry 560 can determine first sums (or first partial sums) of respective ones of the second set of feature channels 216 and second sums (or second partial sums) of respective ones of the third set of feature channels 220. In some examples, the feature channel selection circuitry 560 can group the fifth through tenth feature channels 402, 404, 406, 408, 410, 412 into the first group 438 of the third set of feature channels 220 based on the respective sums of the fifth through tenth feature channels 402, 404, 406, 408, 410, 412 being greater than the sums of the eleventh feature channel 414 and the twelfth feature channel 416. In some examples, the feature channel selection circuitry 560 can group the eleventh feature channel 414 and the twelfth feature channel 416 into a second group of the third set of feature channels 220 based on the sums of the eleventh feature channel 414 and the twelfth feature channel 416 being less than the respective sums of the fifth through tenth feature channels 402, 404, 406, 408, 410, 412.

In some examples, the feature channel selection circuitry 560 can determine that the fifth feature channel 402 has a greater number of salient features than the sixth through twelfth feature channels 404, 406, 408, 410, 412, 414, 416 based on the sum of output values of the fifth feature channel 402 being greater than the respective sums of the sixth through twelfth feature channels 404, 406, 408, 410, 412, 414, 416. In some examples, the feature channel selection circuitry 560 can determine that the fifth feature channel 402 is more important than one(s) of the sixth through twelfth feature channels 404, 406, 408, 410, 412, 414, 416 for training purposes, loss optimization purposes, etc., because the fifth feature channel 402 has a greater number of salient features than one(s) of the sixth through twelfth feature channels 404, 406, 408, 410, 412, 414, 416.

In some examples, the feature channel selection circuitry 560 associates a first feature channel with a relatively low number of salient features and a second feature channel with a relatively high number of salient features to improve the training of the first feature channel by an example feature mimicking technique. For example, the feature channel selection circuitry 560 can determine that the first feature channel 302 has the lowest number of salient features in the first set of feature channels 212; determine that the fourth feature channel 308 has the highest number of salient features in the first set of feature channels 212; and associate the first feature channel 302 and the fourth feature channel 308 during the first intra-layer Tf-SfD operation 228. For example, the feature channel selection circuitry 560 can cause the first feature channel 302 to mimic and/or otherwise track output values of the fourth feature channel 308 based on the association of the first feature channel 302 and the fourth feature channel 308.

In some examples, the feature channel selection circuitry 560 can determine that the fifth feature channel 402 has the highest number of salient features in the third set of feature channels 220; determine that the eighteenth feature channel 428 has the lowest number of salient features in the second set of feature channels 216; and associate the fifth feature channel 402 and the eighteenth feature channel 428 during the first inter-layer Tf-SfD operation 222. For example, the feature channel selection circuitry 560 can cause the eighteenth feature channel 428 to mimic and/or otherwise track output values of the fifth feature channel 402 based on the association of the fifth feature channel 402 and the eighteenth feature channel 428.

The model training circuitry 104A-E of FIG. 5 includes the loss function determination circuitry 570 to determine value(s) of loss function(s), such as one(s) of the loss functions described above in the examples of Equation (3), Equation (4), and/or Equation (5). In some examples, the loss function determination circuitry 570 can perform a first comparison of (i) a first group of a first set of feature channels corresponding to a first layer of a machine learning model and (ii) a second group of the first set of feature channels. For example, the loss function determination circuitry 570 can determine a value (e.g., an error value) of a loss function (e.g., Lossᵢₙₜᵣₐ(X, F_{S})) based on differences between a first group of the first set of feature channels 212 and a second group of the first set of feature channels 212 to effectuate the first intra-layer Tf-SfD operation 228. In some examples, the first set can include the first feature channel 302 and the second feature channel 304 of the first set of feature channels 212. In some examples, the second set can include the third feature channel 306 and the fourth feature channel 308 of the first set of feature channels 212.

In some examples, the loss function determination circuitry 570 can perform a second comparison of (iii) a first group of a second set of feature channels corresponding to a second layer of the machine learning model and one of (iv) a third group of the first set of feature channels or a first group of a third set of feature channels corresponding to a third layer of the machine learning model. For example, the loss function determination circuitry 570 can determine a value (e.g., an error value) of a loss function (e.g., Lossᵢₙₜₑᵣ(X, F_{S})) based on differences between a third set of the first set of feature channels and a fourth set of the third set of feature channels 220 to effectuate the third inter-layer Tf-SfD operation 226. In some examples, the third set can include the first feature channel 302, the second feature channel 304, the third feature channel 306, and the fourth feature channel 308 of the first set of feature channels 212. In some examples, the fourth set can include the fifth feature channel 402, the sixth feature channel 404, the seventh feature channel 406, and the eighth feature channel 408 of the third set of feature channels 220 depicted in FIG. 4.

In some examples, the loss function determination circuitry 570 determines whether an error value associated with the machine learning model satisfies a threshold. For example, the loss function determination circuitry 570 can determine that a first error value of the loss function Lossᵢₙₜᵣₐ(X, F_{S}) is less than a first error threshold and thereby does not satisfy the first error threshold. In some examples, in response to a determination that the first error threshold is not satisfied, the configuration determination circuitry 520 can reconfigure (e.g., generate a new, revised, modified, or updated configuration) the machine learning model architecture 200 to reduce and/or otherwise optimize an error value of the loss function. In some examples, the loss function determination circuitry 570 can determine that the first error value of the loss function Lossᵢₙₜᵣₐ(X, F_{S}) is greater than the first error threshold and thereby satisfies the first error threshold. For example, in response to a determination that the first error threshold is satisfied, the executable generation circuitry 580 can compile and/or otherwise output the machine learning model architecture 200 to execute a workload.

In some examples, the loss function determination circuitry 570 can determine that a second error value of the loss function Lossᵢₙₜₑᵣ(X, F_{S}) is less than a second error threshold and thereby does not satisfy the second error threshold. For example, in response to a determination that the second error threshold is not satisfied, the configuration determination circuitry 520 can reconfigure (e.g., generate a new, revised, modified, or updated configuration) the machine learning model architecture 200 to reduce and/or otherwise optimize an error value of the loss function. In some examples, the loss function determination circuitry 570 can determine that the second error value of the loss function Lossᵢₙₜₑᵣ(X, F_{S}) is greater than the second error threshold and thereby satisfies the second error threshold. For example, in response to a determination that the second error threshold is satisfied, the executable generation circuitry 580 can compile and/or otherwise output the machine learning model architecture 200 to execute a workload.

In some examples, the loss function determination circuitry 570 can determine that a third error value of the loss function (e.g., a loss function based on and/or equal to LOSS_{CE}(X, S)+LOSSᵢₙₜᵣₐ(X, F_{S})+LOSSᵢₙₜₑᵣ(X, F_{S})) is less than a third error threshold and thereby does not satisfy the third error threshold. For example, in response to a determination that the third error threshold is not satisfied, the configuration determination circuitry 520 can reconfigure (e.g., generate a new, revised, modified, or updated configuration) the machine learning model architecture 200 to reduce and/or otherwise optimize an error value of the loss function. In some examples, the loss function determination circuitry 570 can determine that the third error value of the loss function is greater than the third error threshold and thereby satisfies the third error threshold. For example, in response to a determination that the third error threshold is satisfied, the executable generation circuitry 580 can compile and/or otherwise output the machine learning model architecture 200 to execute a workload. In some examples, the first error threshold, the second error threshold, and/or the third error threshold are the same. In some examples, one(s) of the first error threshold, the second error threshold, and/or the third error threshold are different.

The model training circuitry 104A-E of FIG. 5 includes the executable generation circuitry 580 to deploy a machine learning model, such as the machine learning model 596, to execute a workload. In some examples, the executable generation circuitry 580 deploys the machine learning model 596 based on the configuration data 594, which can include a configuration and/or parameters of the machine learning model 596. In some examples, the executable generation circuitry 580 generate an executable (e.g., a machine learning configuration image, an executable file, an executable binary file, etc.) based on a configuration and/or parameters of the ML model 124, the machine learning model architecture 200, etc., and store the executable as the machine learning model 596. In some examples, the executable generation circuitry 580 deploys the machine learning model 596 to execute a workload, such as an AI/ML workload, by generating the executable and causing an execution of the executable to execute the workload (e.g., by processing AI/ML input data with the machine learning model).

The model training circuitry 104A-E of FIG. 5 includes the datastore 590 to record data, such as the training data 592, the configuration data 594, the machine learning model 596, the machine learning executable 598, etc. The datastore 590 can be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The datastore 590 may additionally or alternatively be implemented by one or more double data rate (DDR) memories, such as DDR, DDR2, DDR3, DDR4, DDR5, mobile DDR (mDDR), DDR SDRAM, etc. The datastore 590 may additionally or alternatively be implemented by one or more mass storage devices such as hard disk drive(s) (HDD(s)), compact disk (CD) drive(s), digital versatile disk (DVD) drive(s), solid-state disk (SSD) drive(s), Secure Digital (SD) card(s), CompactFlash (CF) card(s), etc. While in the illustrated example the datastore 590 is illustrated as a single datastore, the datastore 590 may be implemented by any number and/or type(s) of datastores. Furthermore, the data stored in the datastore 590 may be in any data format such as, for example, binary data, comma delimited data, tab delimited data, structured query language (SQL) structures, etc.

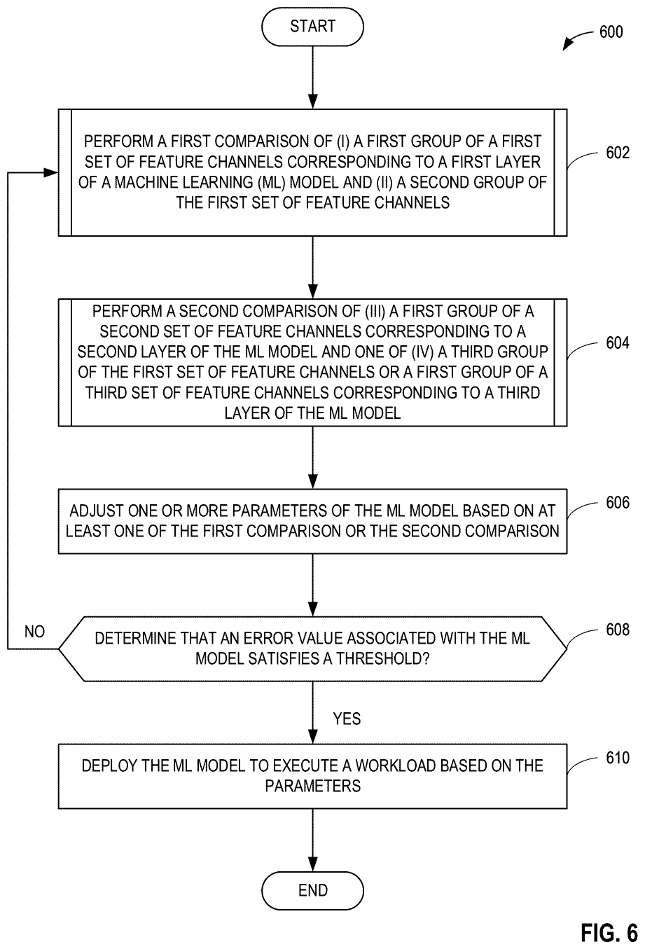

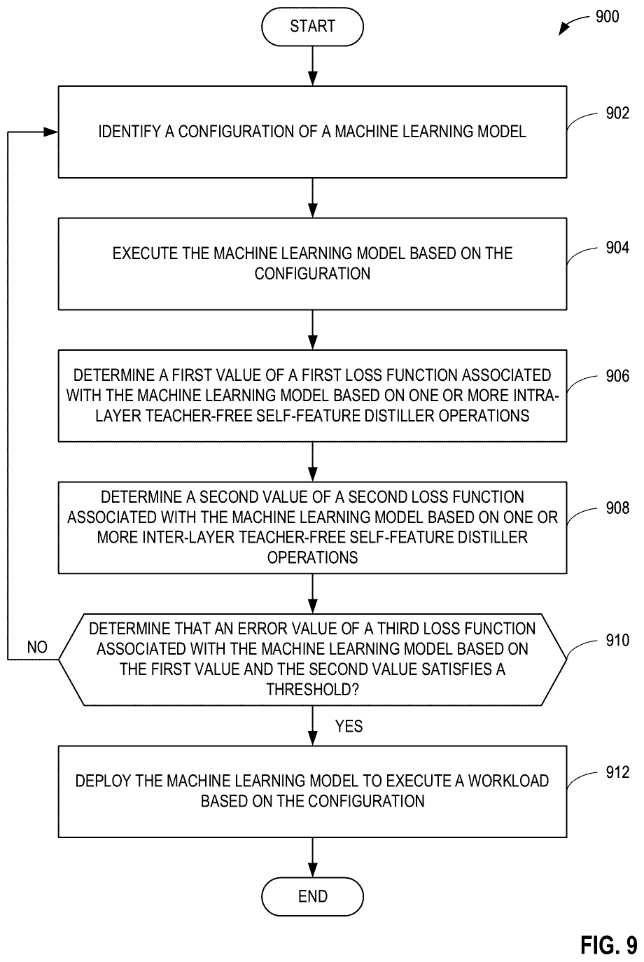

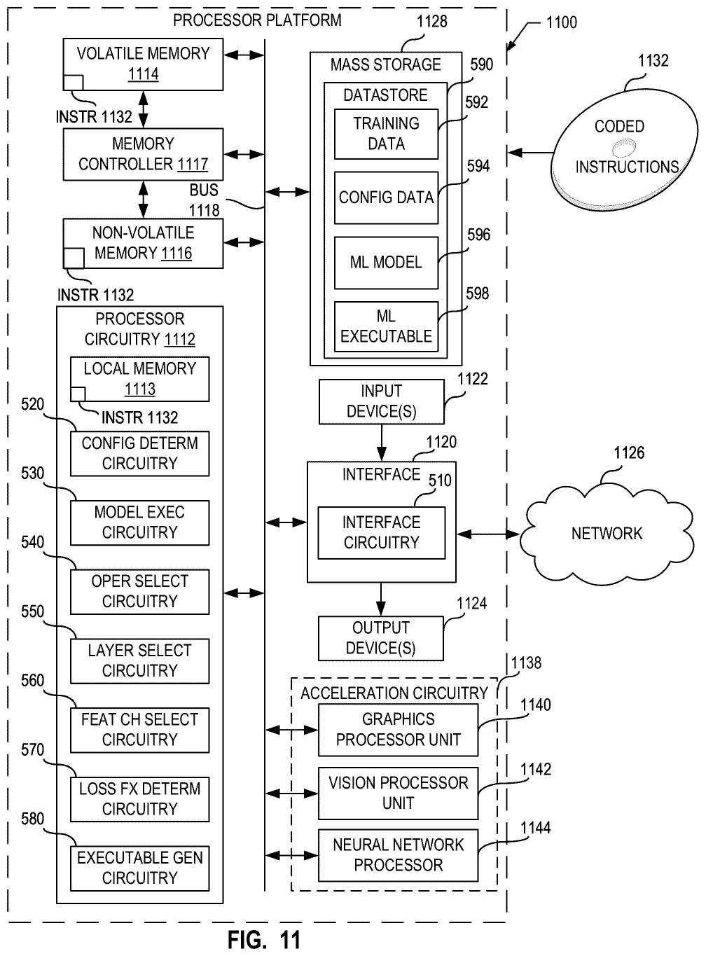

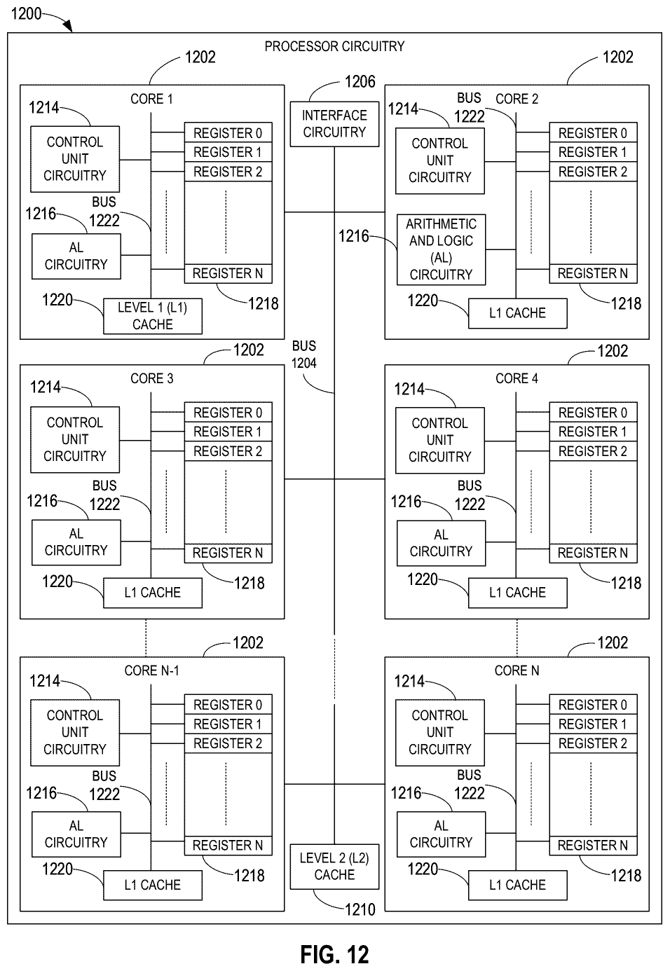

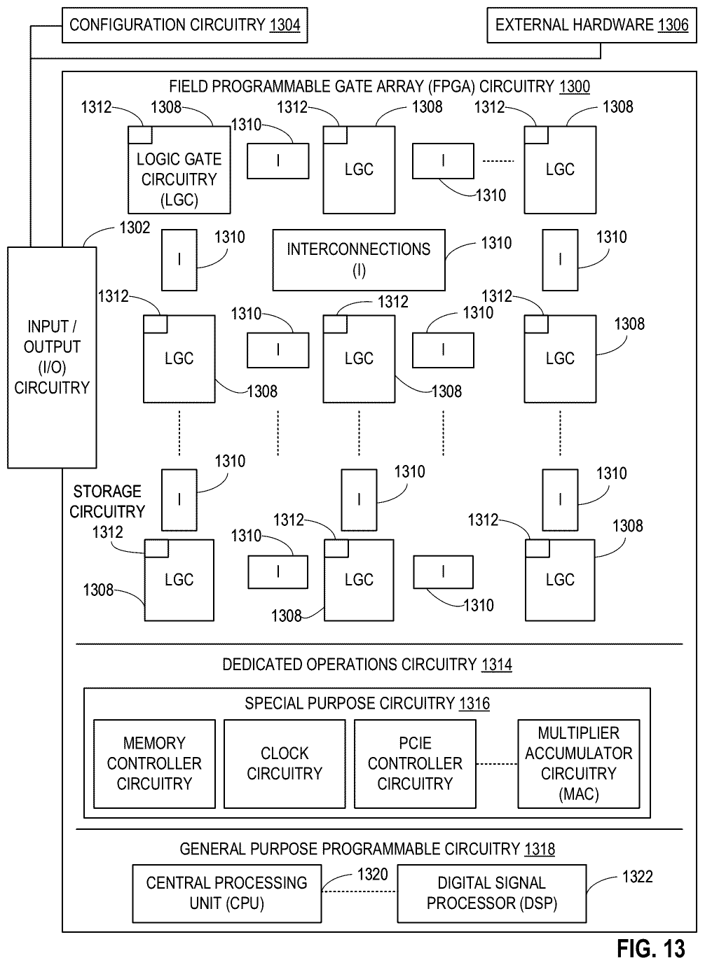

In some examples, the model training circuitry 104A-E includes means for adjusting one or more parameters of a machine learning model based on at least one of a first comparison or a second comparison. For example, the means for adjusting may be implemented by the configuration determination circuitry 520. In some examples, the configuration determination circuitry 520 may be instantiated by processor circuitry such as the example processor circuitry 1112 of FIG. 11. For instance, the configuration determination circuitry 520 may be instantiated by the example general purpose processor circuitry 1200 of FIG. 12 executing machine executable instructions such as that implemented by at least block 606 of FIG. 6 and/or block 902 of FIG. 9. In some examples, the configuration determination circuitry 520 may be instantiated by hardware logic circuitry, which may be implemented by an ASIC or the FPGA circuitry 1300 of FIG. 13 structured to perform operations corresponding to the machine readable instructions. Additionally or alternatively, the configuration determination circuitry 520 may be instantiated by any other combination of hardware, software, and/or firmware. For example, the configuration determination circuitry 520 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples in which a first set of feature channels includes a first feature channel with first output values and a second feature channel with second output values, and a determination is a first determination, the means for adjusting is to, in response to a second determination that an error value does not satisfy a threshold, adjust the one or more parameters to cause the second output values of the second feature channel to mimic the first output values of the first feature channel.

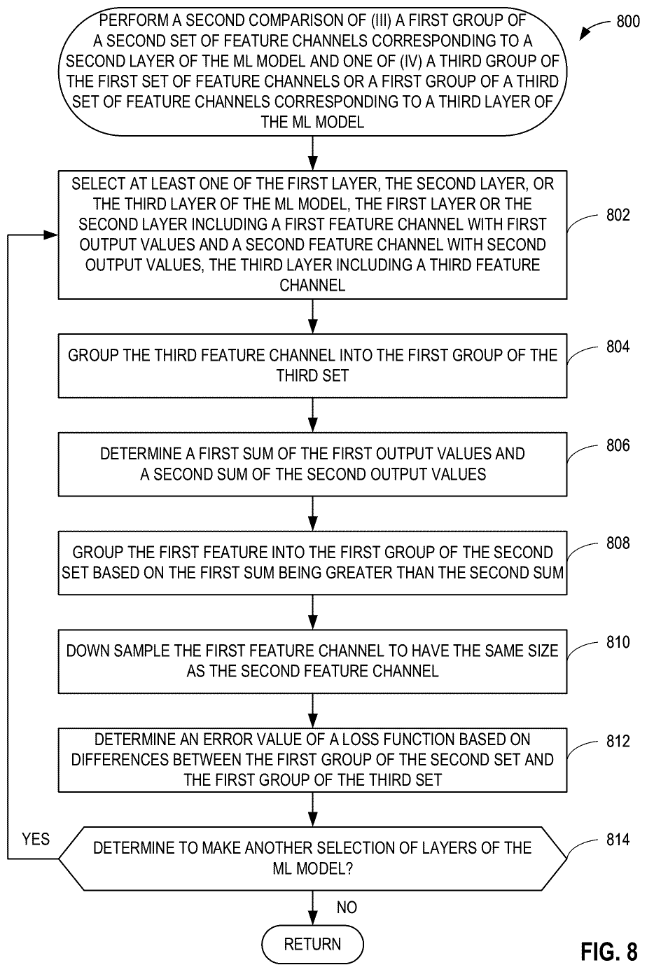

In some examples, the model training circuitry 104A-E includes means for down sampling a first feature channel from a first size to a second size of a second feature channel. For example, the means for down sampling can down sample the first feature channel based on at least one of an average pooling operation on the first feature channel, a maximum pooling operation on the first feature channel, or a change in stride length associated with a convolution operation to generate the first feature operation. In some examples, the means for down sampling may be implemented by the model execution circuitry 530. In some examples, the model execution circuitry 530 may be instantiated by processor circuitry such as the example processor circuitry 1112 of FIG. 11. For instance, the model execution circuitry 530 may be instantiated by the example general purpose processor circuitry 1200 of FIG. 12 executing machine executable instructions such as that implemented by at least block 810 of FIG. 8. In some examples, the model execution circuitry 530 may be instantiated by hardware logic circuitry, which may be implemented by an ASIC or the FPGA circuitry 1300 of FIG. 13 structured to perform operations corresponding to the machine readable instructions. Additionally or alternatively, the model execution circuitry 530 may be instantiated by any other combination of hardware, software, and/or firmware. For example, the model execution circuitry 530 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the model training circuitry 104A-E includes first means for selecting an operation to be applied to a machine learning model. For example, the first means for selecting can select an intra-layer Tf-SfD operation, an inter-layer Tf-SfD operation, a convolution operation, a pooling operation, etc., to be applied to one or more layers, stages, etc., of a machine learning model. In some examples, the first means for selecting may be implemented by the operation selection circuitry 540. In some examples, the operation selection circuitry 540 may be instantiated by processor circuitry such as the example processor circuitry 1112 of FIG. 11. For instance, the operation selection circuitry 540 may be instantiated by the example general purpose processor circuitry 1200 of FIG. 12 executing machine executable instructions such as that implemented by at least block 802 of FIG. 8. In some examples, the operation selection circuitry 540 may be instantiated by hardware logic circuitry, which may be implemented by an ASIC or the FPGA circuitry 1300 of FIG. 13 structured to perform operations corresponding to the machine readable instructions. Additionally or alternatively, the operation selection circuitry 540 may be instantiated by any other combination of hardware, software, and/or firmware. For example, the operation selection circuitry 540 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the model training circuitry 104A-E includes second means for selecting a layer of a machine learning model. For example, the second means for selecting can select at least one of a first layer, a second layer, or a third layer of a machine learning model. In some examples, the second means for selecting may be implemented by the layer selection circuitry 550. In some examples, the layer selection circuitry 550 may be instantiated by processor circuitry such as the example processor circuitry 1112 of FIG. 11. For instance, the layer selection circuitry 550 may be instantiated by the example general purpose processor circuitry 1200 of FIG. 12 executing machine executable instructions such as that implemented by at least block 802 of FIG. 8. In some examples, the layer selection circuitry 550 may be instantiated by hardware logic circuitry, which may be implemented by an ASIC or the FPGA circuitry 1300 of FIG. 13 structured to perform operations corresponding to the machine readable instructions. Additionally or alternatively, the layer selection circuitry 550 may be instantiated by any other combination of hardware, software, and/or firmware. For example, the layer selection circuitry 550 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

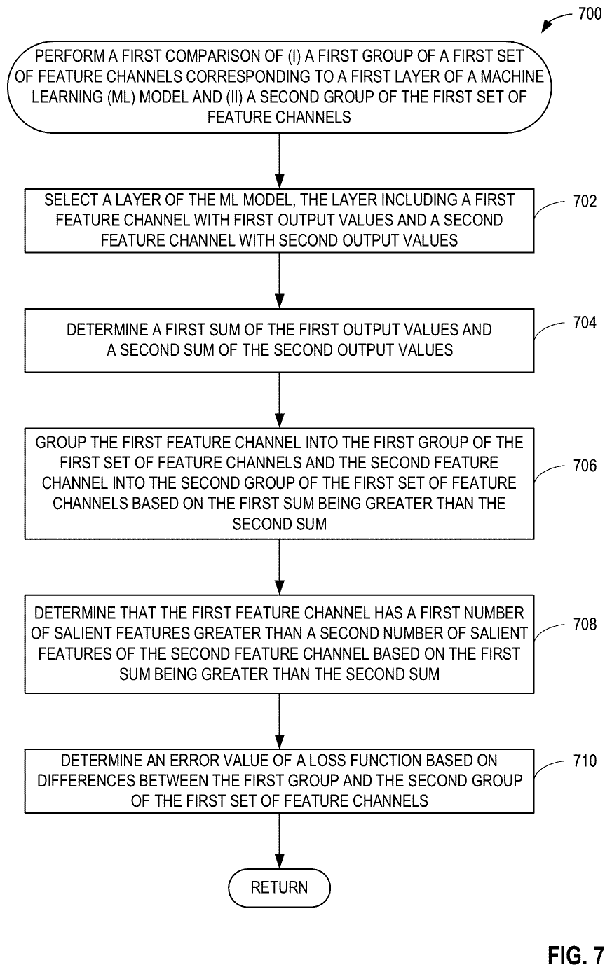

In some examples, the model training circuitry 104A-E includes means for determining to determine a first sum of first output values and a second sum of second output values. For example, a first set of feature channels can include a first feature channel with the first output values and a second feature channel with the second output values. In some examples, the means for determining may be implemented by the feature channel selection circuitry 560. In some examples, the feature channel selection circuitry 560 may be instantiated by processor circuitry such as the example processor circuitry 1112 of FIG. 11. For instance, the feature channel selection circuitry 560 may be instantiated by the example general purpose processor circuitry 1200 of FIG. 12 executing machine executable instructions such as that implemented by at least blocks 704, 706, 708 of FIG. 7 and blocks 804, 806, 808 of FIG. 8. In some examples, the feature channel selection circuitry 560 may be instantiated by hardware logic circuitry, which may be implemented by an ASIC or the FPGA circuitry 1300 of FIG. 13 structured to perform operations corresponding to the machine readable instructions. Additionally or alternatively, the feature channel selection circuitry 560 may be instantiated by any other combination of hardware, software, and/or firmware. For example, the feature channel selection circuitry 560 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the means for determining is to group a first feature channel into a first group of a first set of feature channels and a second feature channel into a second group of the first set of feature channels based on a first sum of first output values of the first feature channel being greater than a second sum of second output values of the second feature channel. In some examples, the means for determining is to determine that the first feature channel has a first number of salient features greater than a second number of salient features of the second feature channel based on the first sum being greater than the second sum.

In some examples in which a second set of feature channels includes a first feature channel with first output values and a second feature channel with second output values, and a third set of feature channels includes a third feature channel, the means for determining is to group the third feature channel into the first group of the third set; determine a first sum of the first output values and a second sum of the second output values; and group the first feature channel into the first group of the second set based on the first sum being greater than the second sum.

In some examples, the model training circuitry 104A-E includes means for comparing feature channels and/or aspect(s) thereof. For example, the means for comparing can perform a first comparison of (i) a first group of a first set of feature channels corresponding to a first layer of a machine learning model and (ii) a second group of the first set of feature channels. In some examples, the means for comparing can perform a second comparison of (iii) a first group of a second set of feature channels corresponding to a second layer of the machine learning model and one of (iv) a third group of the first set of feature channels or a first group of a third set of feature channels corresponding to a third layer of the machine learning model. In some examples, the means for comparing may be implemented by the loss function determination circuitry 570. In some examples, the loss function determination circuitry 570 may be instantiated by processor circuitry such as the example processor circuitry 1112 of FIG. 11. For instance, the loss function determination circuitry 570 may be instantiated by the example general purpose processor circuitry 1200 of FIG. 12 executing machine executable instructions such as that implemented by at least blocks 602, 604, 608 of FIG. 6, block 710 of FIG. 7, block 812 of FIG. 8, and blocks 906, 908, 910 of FIG. 9. In some examples, the loss function determination circuitry 570 may be instantiated by hardware logic circuitry, which may be implemented by an ASIC or the FPGA circuitry 1300 of FIG. 13 structured to perform operations corresponding to the machine readable instructions. Additionally or alternatively, the loss function determination circuitry 570 may be instantiated by any other combination of hardware, software, and/or firmware. For example, the loss function determination circuitry 570 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples in which a first set of feature channels includes a first feature channel with first output values and a second feature channel with second output values, and an error value is a first error value, the means for comparing is to determine a second error value of a loss function based on differences between the first group and the second group of the first set of feature channels. In some examples in which a first set of feature channels includes a first feature channel with first output values and a second feature channel with second output values, and the means for comparing is to determine the error value based on adjusted one or more parameters. In some examples in which a second set of feature channels includes a first feature channel with first output values and a second feature channel with second output values, and the third set of feature channels includes a third feature channel, the means for comparing is to determine the error value of a loss function based on differences between the first group of the third set and the first group of the second set.

In some examples, the model training circuitry 104A-E includes means for deploying a machine learning model to execute a workload based on one or more parameters. For example, the means for deploying can deploy the machine learning model in response to a determination that an error value associated with the machine learning model satisfies a threshold. In some examples, the means for deploying may be implemented by the executable generation circuitry 580. In some examples, the executable generation circuitry 580 may be instantiated by processor circuitry such as the example processor circuitry 1112 of FIG. 11. For instance, the executable generation circuitry 580 may be instantiated by the example general purpose processor circuitry 1200 of FIG. 12 executing machine executable instructions such as that implemented by at least block 610 of FIG. 6 and block 912 of FIG. 9. In some examples, the executable generation circuitry 580 may be instantiated by hardware logic circuitry, which may be implemented by an ASIC or the FPGA circuitry 1300 of FIG. 13 structured to perform operations corresponding to the machine readable instructions. Additionally or alternatively, the executable generation circuitry 580 may be instantiated by any other combination of hardware, software, and/or firmware. For example, the executable generation circuitry 580 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the model training circuitry 104A-E of FIGS. 1-4 is illustrated in FIG. 5, one or more of the elements, processes, and/or devices illustrated in FIG. 5 may be combined, divided, re-arranged, omitted, eliminated, and/or implemented in any other way. Further, the bus 505, the interface circuitry 510, the configuration determination circuitry 520, the model execution circuitry 530, the operation selection circuitry 540, the layer selection circuitry 550, the feature channel selection circuitry 560, the loss function determination circuitry 570, the executable generation circuitry 580, the datastore 590, and/or, more generally, the example model training circuitry 104A-E of FIGS. 1-4, may be implemented by hardware alone or by hardware in combination with software and/or firmware. Thus, for example, any of the bus 505, the interface circuitry 510, the configuration determination circuitry 520, the model execution circuitry 530, the operation selection circuitry 540, the layer selection circuitry 550, the feature channel selection circuitry 560, the loss function determination circuitry 570, the executable generation circuitry 580, the datastore 590, and/or, more generally, the example model training circuitry 104A-E, could be implemented by processor circuitry, analog circuit(s), digital circuit(s), logic circuit(s), programmable processor(s), programmable microcontroller(s), GPU(s), DSP(s), ASIC(s), PLD(s), and/or FPLD(s) such as FPGAs. Further still, the example model training circuitry 104A-E of FIGS. 1-4 may include one or more elements, processes, and/or devices in addition to, or instead of, those illustrated in FIG. 5, and/or may include more than one of any or all of the illustrated elements, processes and devices.

Flowcharts representative of example hardware logic circuitry, machine readable instructions, hardware implemented state machines, and/or any combination thereof for implementing the model training circuitry 104A-E of FIGS. 1-5 are shown in FIGS. 6-9. The machine readable instructions may be one or more executable programs or portion(s) of an executable program for execution by processor circuitry, such as the processor circuitry 1112 shown in the example processor platform 1100 discussed below in connection with FIG. 11 and/or the example processor circuitry discussed below in connection with FIGS. 12 and/or 13. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 6-9, many other methods of implementing the example model training circuitry 104A-E may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6-9 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 6 is a flowchart representative of example machine readable instructions and/or example operations 600 that may be executed and/or instantiated by processor circuitry for teacher-free self-feature distillation training of a machine learning model. The machine readable instructions and/or the operations 600 of FIG. 6 begin at block 602, at which the model training circuitry 104A-E performs a first comparison of (i) a first group of a first set of feature channels corresponding to a first layer of a machine learning (ML) model and (ii) a second group of the first set of feature channels. An example process that may be executed and/or instantiated by processor circuitry to implement block 602 is described below in connection with FIG. 7.

To implement block 602 by way of example, the configuration determination circuitry 520 (FIG. 5) can configure the machine learning model architecture 200 based on a configuration, such as the configuration data 594 (FIG. 5). In some examples, the model execution circuitry 530 (FIG. 5) can execute the machine learning model architecture 200 by way of the forward training processes 206 based on the training data 204 as model input(s) to generate output values of the first set of feature channels 212, the second set of feature channels 216, and/or the third set of feature channels 220. The operation selection circuitry 540 can improve training of the machine learning model architecture 200 without the use of a teacher machine learning model by executing one(s) of the intra-layer Tf-SfD operations 228, 230, 232. For example, the operation selection circuitry 540 can select the first intra-layer Tf-SfD operation 228 to improve the training of the machine learning model architecture 200 with reduced computational costs (e.g., reduced acceleration, compute, memory, storage, etc., resources) and/or improved accuracy (e.g., reduced error). In some examples, the layer selection circuitry 550 (FIG. 5) can select a first layer of the machine learning model architecture 200, which can be the first stage 210 and/or the first set of feature channels 212. In some examples, the feature channel selection circuitry 560 (FIG. 5) can select the first feature channel 302 and the second feature channel 304 to be included in the first group 310 of the first set of feature channels 212; select the third feature channel 306 and the fourth feature channel 308 to be included in the second group 312 of the first set of feature channels 212; and determine a value (e.g., an error value) of a loss function based on differences between the first group and the second group. In some examples, the differences can be at least one of (i) differences between first output values of the first feature channel 302 and fourth output values of the fourth feature channel 308 or (ii) differences between second output values of the second feature channel 304 and third output values of the third feature channel 306.

At block 604, the model training circuitry 104A-E performs a second comparison of (iii) a first group of a second set of feature channels corresponding to a second layer of the ML model and one of (iv) a third group of the first set of feature channels or a first group of a third set of feature channels corresponding to a third layer of the ML model. An example process that may be executed and/or instantiated by processor circuitry to implement block 604 is described below in connection with FIG. 8.

To implement block 604 by way of example, the operation selection circuitry 540 can improve training of the machine learning model architecture 200 without the use of a teacher machine learning model by executing one(s) of the inter-layer Tf-SfD operations 222, 224, 226. For example, the operation selection circuitry 540 can select the first inter-layer Tf-SfD operation 222 to improve the training of the machine learning model architecture 200 with reduced computational costs and/or improved accuracy (e.g., reduced error). In some examples, the layer selection circuitry 550 can select a second layer of the machine learning model architecture 200, which can be the second stage 214 and/or the second set of feature channels 216. In some examples, the layer selection circuitry 550 can select a third layer of the machine learning model architecture 200, which can be the third stage 218 and/or the third set of feature channels 220.

In some examples, the feature channel selection circuitry 560 can select the nineteenth feature channel 430, the twentieth feature channel 432, the twenty-first feature channel 434, and the twenty-second feature channel 436 to be included in a third group of the first set of feature channels 212. In some examples, the feature channel selection circuitry 560 can select the fifth through tenth feature channels 402, 404, 406, 408, 410, 412 to be included in the first group 438 of the third set of feature channels 220. In some examples, the feature channel selection circuitry 560 can determine a value (e.g., an error value) of a loss function based on differences between the third group of the first set of feature channels 212 and the first group 438 of the third set of feature channels 220. In some examples, the differences can be (i) differences between output values of the fifth feature channel 402 and output values of the twenty-second feature channel 436, (ii) differences between output values of the sixth feature channel 404 and output values of the twenty-first feature channel 434, etc., and/or any combination(s) thereof.

At block 606, the model training circuitry 104A-E adjusts one or more parameters of the ML model based on at least one of the first comparison or the second comparison. For example, the configuration determination circuitry 520 can adjust, change, and/or otherwise modify one or more parameters of the machine learning model architecture 200 to minimize and/or otherwise reduce loss function(s) described above in connection with Equation (3), Equation (4), and/or Equation (5) to increase an accuracy (e.g., reduce error) of the machine learning model architecture 200. In some examples, the configuration determination circuitry 520 can adjust parameters of the first stage 210, which can include weight values of a convolution filter, to reduce the loss function Lossᵢₙₜᵣₐ(X, F_{S}) described above in the example of Equation (4) and/or the loss function Lossᵢₙₜₑᵣ(X, F_{S}) described above in the example of Equation (5). Additionally and/or alternatively, the configuration determination circuitry 520 can adjust any other parameter associated with the machine learning model architecture 200 to reduce the loss function Lossᵢₙₜᵣₐ(X, F_{S}) described above in the example of Equation (4) and/or the loss function Lossᵢₙₜₑᵣ(X, F_{S}) described above in the example of Equation (5).

At block 608, the model training circuitry 104A-E determines whether an error value associated with the ML model satisfies a threshold. For example, the loss function determination circuitry 570 (FIG. 5) can determine that a first error value of the loss function Lossᵢₙₜᵣₐ(X, F_{S}) satisfies a first threshold (e.g., a loss function threshold, an error threshold, an accuracy threshold, etc.), a second error value of the loss function Lossᵢₙₜᵣₐ(X, F_{S}) satisfies the first threshold or a second threshold (e.g., a loss function threshold, an error threshold, an accuracy threshold, etc.), etc., and/or any combination(s) thereof, in response to a determination that the first error value and/or the second error value is greater than the first threshold and/or the second threshold.

If, at block 608, the model training circuitry 104A-E determines that an error value associated with the ML model does not satisfy a threshold, control returns to block 602 to perform a first comparison of (i) a first group of a first set of feature channels corresponding to a first layer of a machine learning (ML) model and (ii) a second group of the first set of feature channels based on the adjusted parameters of the ML model. If, at block 608, the model training circuitry 104A-E determines that an error value associated with the ML model satisfies a threshold, then, at block 610, the model training circuitry 104A-E deploys the ML model to execute a workload based on the parameters. For example, the executable generation circuitry 580 (FIG. 5) can compile and/or otherwise output an executable construct based on the machine learning model architecture 200. In some examples, one(s) of the hardware accelerators 108, 110 of FIG. 1, one(s) of the external electronic systems 130 of FIG. 1, etc., and/or any combination(s) thereof, can deploy, execute, and/or otherwise instantiate the executable construct to execute AI/ML workload(s). In response to deploying the ML model to execute a workload based on the parameters at block 610, the example machine readable instructions and/or the example operations 600 of FIG. 6 conclude.

FIG. 7 is a flowchart representative of example machine readable instructions and/or example operations 700 that may be executed and/or instantiated by processor circuitry to determine a first error value of a first loss function. In some examples, the machine readable instructions and/or the operations 700 of FIG. 7 can be executed and/or instantiated by processor circuitry to implement block 602 of FIG. 6. The machine readable instructions and/or the operations 700 of FIG. 7 begin at block 702, at which the model training circuitry 104A-E selects a layer of the ML model, the layer including a first feature channel with first output values and a second feature channel with second output values. For example, the operation selection circuitry 540 (FIG. 5) can select the first intra-layer Tf-SfD operation 228 to apply to a first layer of the machine learning model architecture 200, which can include the first feature channel 302 and the fourth feature channel 308. In some examples, the fourth feature channel 308 can have first output values and the first feature channel 302 can have second output values.

At block 704, the model training circuitry 104A-E determines a first sum of the first output values and a second sum of the second output values. For example, the feature channel selection circuitry 560 (FIG. 5) can calculate a first sum of the first output values and a second sum of the second output values.

At block 706, the model training circuitry 104A-E groups the first feature channel into the first group of the first set of feature channels and the second feature channel into the second group of the first set of feature channels based on the first sum being greater than the second sum. For example, the feature channel selection circuitry 560 can aggregate, group in, and/or otherwise associate the fourth feature channel 308 with the first group of the first set of feature channels 212 and the first feature channel 302 with the second group of the first set of feature channels 212 in response to a determination that the first sum is greater than the second sum.

At block 708, the model training circuitry 104A-E determines that the first feature channel has a first number of salient features greater than a second number of salient features of the second feature channel based on the first sum being greater than the second sum. For example, the feature channel selection circuitry 560 can determine that the fourth feature channel 308 has a greater number of salient features than the first feature channel 302 in response to a determination that the first sum is greater than the second sum.

At block 710, the model training circuitry 104A-E determines an error value of a loss function based on differences between the first group and the second group of the first set of feature channels. For example, the loss function determination circuitry 570 can determine an error value of a loss function, such as Lossᵢₙₜᵣₐ(X, F_{S}) of the example of Equation (4) above, based on differences between the first feature channel 302 and the fourth feature channel 308. Advantageously, the first feature channel 302 can mimic and/or otherwise track the output values of the fourth feature channel 308 for improved training of the first feature channel 302 without using a teacher machine learning model. In response to determining an error value of a loss function based on differences between the first group and the second group of the first set of feature channels, the example machine readable instructions and/or the operations 700 of FIG. 7 conclude. For example, the machine readable instructions and/or the operations 700 of FIG. 7 can return to block 604 of the machine readable instructions and/or the operations 600 of FIG. 6.

FIG. 8 is a flowchart representative of example machine readable instructions and/or example operations 800 that may be executed and/or instantiated by processor circuitry to determine a second error value of a second loss function. In some examples, the machine readable instructions and/or the operations 800 of FIG. 8 can be executed and/or instantiated by processor circuitry to implement block 604 of FIG. 6. The machine readable instructions and/or the operations 800 of FIG. 8 begin at block 802, at which the model training circuitry 104A-E selects at least one of the first layer, the second layer, or the third layer of the ML model, the first layer or the second layer including a first feature channel with first output values and a second feature channel with second output values, and the third layer including a third feature channel. For example, the operation selection circuitry 540 (FIG. 5) can select the first inter-layer Tf-SfD operation 222 to apply to (i) a second layer of the machine learning model architecture 200, which can include the second stage 214 and/or the second set of feature channels 216, and (ii) a third layer of the machine learning model architecture 200, which can include the third stage 218 and/or the third set of feature channels 220. In some examples, the second set of feature channels 216 can include the thirteenth feature channel 418. In some examples, the third set of feature channels 220 can include the fifth feature channel 402 with first output values and the twelfth feature channel 416 with second output values.

At block 804, the model training circuitry 104A-E groups the third feature channel into the first group of the third set. For example, the feature channel selection circuitry 560 can group the thirteenth feature channel 418 into a first group of the second set of feature channels 216. In some examples, the first group of the second set of feature channels 216 can include the thirteenth through the eighteenth feature channels 418, 420, 422, 424, 426, 428.

At block 806, the model training circuitry 104A-E determines a first sum of the first output values and a second sum of the second output values. For example, the feature channel selection circuitry 560 can determine the first sum (or first partial sum) of the first output values of the fifth feature channel 402 and the second sum (or second partial sum) of the second output values of the twelfth feature channel 416.

At block 808, the model training circuitry 104A-E groups the first feature into the first group of the second set based on the first sum being greater than the second sum. For example, the feature channel selection circuitry 560 can group the fifth feature channel 402 in the first group 438 of FIG. 4 in response to a determination that the first sum is greater than the second sum, which can indicate that the fifth feature channel 402 has greater saliency than the twelfth feature channel 416.

At block 810, the model training circuitry 104A-E down samples the first feature channel to have the same size as the second feature channel. For example, the model execution circuitry 530 (FIG. 5) can down sample the thirteenth feature channel 418 via an AI/ML operation such as a pooling operation. In some examples, the thirteenth feature channel 418 can have a first size (e.g., a first height, length, and/or width) and the fifth feature channel 402 can have a second size (e.g., a second height, length, and/or width smaller than the first height, length, and/or width). For example, the model execution circuitry 530 can down sample the thirteenth feature channel 418 from the first size to the second size.

At block 812, the model training circuitry 104A-E determines an error value of a loss function based on differences between the first group of the second set and the first group of the third set. For example, the loss function determination circuitry 570 can determine an error value of a loss function, such as Lossᵢₙₜₑᵣ(X, F_{S}) of the example of Equation (5) above, based on differences between the fifth feature channel 402 and the thirteenth feature channel 418. Advantageously, the thirteenth feature channel 418 can mimic and/or otherwise track the output values of the fifth feature channel 402 for improved training of the thirteenth feature channel 418 without using a teacher machine learning model. In response to determining an error value of a loss function based on differences between the first group of the second set and the first group of the third set, the example machine readable instructions and/or the operations 800 of FIG. 8 conclude. For example, the machine readable instructions and/or the operations 800 of FIG. 8 can return to block 606 of the machine readable instructions and/or the operations 600 of FIG. 6.

FIG. 9 is a flowchart representative of example machine readable instructions and/or example operations 900 that may be executed and/or instantiated by processor circuitry for teacher-free self-feature distillation training of a machine learning model. The machine readable instructions and/or the operations 900 of FIG. 9 begin at block 902, at which the model training circuitry 104A-E identifies a configuration of a machine learning model. For example, the configuration determination circuitry 520 (FIG. 5) can identify a configuration of the machine learning model architecture 200 of FIG. 2. In some examples, the configuration determination circuitry 520 can identify the configuration to include a topology of one or more stages, such as one(s) of the stages 210, 214, 218, and associated interconnections, such as output(s) of the first stage 210 to be coupled to input(s) of the second stage 214, etc. In some examples, the configuration determination circuitry 520 can identify the configuration to include a type of AI/ML operation (e.g., a type of AI/ML operation to be implemented by a layer, a stage, etc.), which can include a convolution operation, a pooling operation, etc. In some examples, the configuration determination circuitry 520 can identify the configuration to include activation values, weight values, a size of a filter (e.g., a convolution filter), etc., that may be implemented by one or more layers, stages, etc., of the machine learning model architecture 200. In some examples, the configuration determination circuitry 520 can configure, set, etc., the machine learning model architecture 200 into one or more configurations during a training phase, an inference phase, etc.

At block 904, the model training circuitry 104A-E executes the machine learning model based on the configuration. For example, the model execution circuitry 530 (FIG. 5) can cause an execution of the machine learning model architecture 200 (e.g., execute on one(s) of the hardware accelerators 108, 110) by way of the forward training processes 206, the backwards training processes 208, etc., during a training phase to generate and/or otherwise output one(s) of the first set of feature channels 212, the second set of feature channels 216, the third set of feature channels 220, etc. In some examples, the model execution circuitry 530 can execute (e.g., on one(s) of the hardware accelerators 108, 110) the machine learning model architecture 200 during an inference phase to generate and/or otherwise output one(s) of the first set of feature channels 212, the second set of feature channels 216, the third set of feature channels 220, etc.

At block 906, the model training circuitry 104A-E determines a first value of a first loss function associated with the machine learning model based on one or more intra-layer teacher-free self-feature distiller operations. For example, in response to execution(s) of one(s) of the intra-layer Tf-SfD operations 228, 230, 232, the loss function determination circuitry 570 (FIG. 5) can determine a first value of the loss function Lossᵢₙₜᵣₐ described above in connection with the example of Equation (4) above.

At block 908, the model training circuitry 104A-E determines a second value of a second loss function associated with the machine learning model based on one or more inter-layer teacher-free self-feature distiller operations. For example, in response to execution(s) of one(s) of the inter-layer Tf-SfD operations 222, 224, 226, the loss function determination circuitry 570 can determine a second value of the loss function Lossᵢₙₜₑᵣ described above in connection with the example of Equation (5) above.

At block 910, the model training circuitry 104A-E determines whether an error value of a third loss function associated with the machine learning model based on the first value and the second value satisfies a threshold. For example, the loss function determination circuitry 570 can determine whether a third value of the loss function LOSS_{CE}(X, S)+LOSSᵢₙₜᵣₐ(X, F_{S})+LOSSᵢₙₜₑᵣ(X, F_{S}) described above in the example of Equation (3) satisfies a threshold (e.g., an error threshold, a training threshold, etc.). In some examples, the loss function determination circuitry 570 can determine that retraining (e.g., additional training, further training, etc.) of the machine learning model architecture 200 is to be conducted to optimize and/or otherwise improve an accuracy (e.g., reduce an error) of the machine learning model architecture 200 in response to the third value being less than the threshold. In some examples, the loss function determination circuitry 570 can determine that retraining of the machine learning model architecture 200 is not to be conducted in response to the third value being greater than (and/or equal to) the threshold because the machine learning model architecture 200 has achieved a pre-determined and/or otherwise sufficient level of training.

If, at block 910, the model training circuitry 104A-E determines that an error value of a third loss function associated with the machine learning model based on the first value and the second value does not satisfy a threshold, control returns to block 902 to identify another configuration of the machine learning model to effectuate retraining. If, at block 910, the model training circuitry 104A-E determines that an error value of a third loss function associated with the machine learning model based on the first value and the second value satisfies a threshold, then, at block 912, the model training circuitry 104A-E deploys the machine learning model to execute a workload based on the configuration. For example, the executable generation circuitry 580 (FIG. 5) can compile and/or otherwise generate an executable construct, such as an AI/ML configuration image, an executable file, etc., that can be instantiated by one(s) of the hardware accelerators 108, 110 to execute AI/ML workload(s). In some examples, the executable generation circuitry 580 can store the executable construct as the machine learning executable 598 (FIG. 5) in the datastore 590 (FIG. 5). In response to deploying the machine learning model to execute a workload based on the configuration at block 912, the example machine readable instructions and/or the example operations 900 conclude.

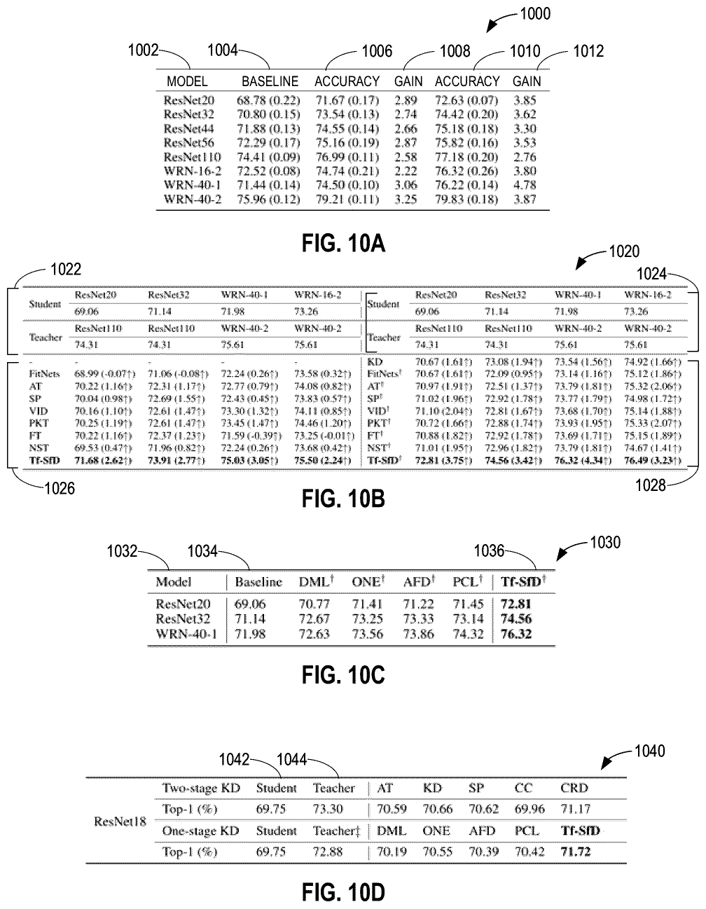

FIGS. 10A-10D are tables 1000, 1020, 1030, 1040 depicting example improvements of the model training circuitry 104A-E training a machine learning model, such as the ML model 124 of FIG. 1 and/or the machine learning model architecture 200 of FIG. 2, with respect to conventional machine learning model training techniques (e.g., two-stage techniques, one-stage techniques, etc.). For example, the model training circuitry 104A-E can train the machine learning model architecture 200 with reduced training costs (e.g., 3 times training cost reduction, 10 times training cost reduction, 20 times training cost reduction, etc.) and/or improved performance by executing the intra-layer Tf-SfD operations 228, 230, 232 and/or the inter-layer Tf-SfD operations 222, 224, 226 to optimize and/or otherwise reduce model error as exemplified by the tables 1000, 1020, 1030, 1040 of FIGS. 10A-10D.

The illustrated example of FIG. 10A is a first table 1000 that depicts accuracies (e.g., recognition rates) of various machine learning models (e.g., ResNet20, ResNet32, etc.) (depicted by table column identified by reference numeral 1002) based on conventional machine learning model training techniques for model training with data augmentation (depicted by table column identified by reference numeral 1004). The first table 1000 depicts accuracies (depicted by table column identified by reference numeral 1006) of the various machine learning models after Tf-SfD model training without data augmentation. The first table 1000 depicts gains (depicted by table column identified by reference numeral 1008) of the Tf-SfD model training without data augmentation with respect to the conventional machine learning model training techniques. The first table 1000 depicts accuracies (depicted by table column identified by reference numeral 1010) of the various machine learning models after Tf-SfD model training with data augmentation. The first table 1000 depicts gains (depicted by table column identified by reference numeral 1012) of the Tf-SfD model training with data augmentation with respect to the conventional machine learning model training techniques. The training of the various models is based on training data (e.g., the CIFAR-100 dataset or any other training dataset).

By way of example, a ResNet20 model can be trained with a conventional machine learning model training technique to achieve an accuracy of 68.78 (e.g., 68.78%). The model training circuitry 104A-E can train the same ResNet20 model with Tf-SfD techniques as described herein (e.g., by executing one or more inter-layer Tf-SfD operations, one or more intra-layer Tf-SfD operations, etc.) without data augmentation to achieve an accuracy of 71.67, which is a gain of 2.89 over the conventional machine learning model training technique. The model training circuitry 104A-E can train the same ResNet20 model with Tf-SfD techniques as described herein with data augmentation to achieve an accuracy of 72.63, which is a 3.85 gain over the conventional machine learning model training technique.

The illustrated example of FIG. 10B is a second table 1020 that depicts accuracies (e.g., recognition rates) of various machine learning models (e.g., ResNet20, ResNet32, etc.) based on independent trained baselines without data augmentation (table rows identified by reference numeral 1022) and with data augmentation (table rows identified by reference numeral 1024) based on training data (e.g., the CIFAR-100 dataset or any other training dataset) using a two-stage machine learning model training technique. The second table 1020 depicts accuracies of various machine learning models (e.g., ResNet20, ResNet32, etc.) after being trained with conventional two-stage machine learning model training techniques (e.g., teacher-student knowledge distillation techniques), such as FitNets, AT, SP, VID, PKT, FT, and NST, without data augmentation (depicted by table rows identified by reference numeral 1022) and with data augmentation (depicted by table rows identified by reference numeral 1024) based on the training data.

By way of example, a ResNet20 model can be trained with an independent trained baseline to achieve an accuracy of 69.06 (e.g., 69.06%). The same ResNet20 model can be trained with a conventional two-stage machine learning model training technique, such as FitNets, without data augmentation to achieve an accuracy of 68.99. The model training circuitry 104A-E can train the same ResNet20 model with Tf-SfD techniques as described herein (e.g., by executing one or more inter-layer Tf-SfD operations, one or more intra-layer Tf-SfD operations, etc.) without data augmentation to achieve an accuracy of 71.68, which is a gain of 2.62 over the independent trained baseline and a gain of 2.69 over the FitNets technique. The model training circuitry 104A-E can train the same ResNet20 model with Tf-SfD techniques as described herein with data augmentation to achieve an accuracy of 72.81, which is a 3.75 gain over the independent trained baseline and a gain of 2.14 over the FitNets technique. Advantageously, the model training circuitry 104A-E can train an AI/ML model, such as ResNet20, with reduced training costs and improved performance (e.g., improved accuracy, recognition rates, etc.) without a teacher machine learning model over conventional two-stage machine learning model training techniques.

The illustrated example of FIG. 10C is a third table 1030 that depicts accuracies (e.g., recognition rates) of various machine learning models (e.g., ResNet20, ResNet32, etc.) using one-stage machine learning model training techniques. The third table 1030 depicts accuracies of various machine learning models (depicted by table column identified by reference numeral 1032) after being trained with an independent trained baseline (depicted by table column identified by reference numeral 1034). The third table 1030 depicts accuracies of the various machine learning models after being trained with conventional one-stage machine learning model training techniques (e.g., DML, ONE, AFD, PCL). The third table 1030 depicts accuracies of the various machine learning models after being trained with Tf-SfD techniques as described herein (e.g., by executing one or more inter-layer Tf-SfD operations, one or more intra-layer Tf-SfD operations, etc.) (table column identified by reference numeral 1036.

By way of example, a ResNet20 model can be trained with an independent trained baseline to achieve an accuracy of 69.06 (e.g., 69.06%). The same ResNet20 model can be trained with a conventional one-stage machine learning model training technique, such as DML, to achieve an accuracy of 70.77. The model training circuitry 104A-E can train the same ResNet20 model with Tf-SfD techniques as described herein (e.g., by executing one or more inter-layer Tf-SfD operations, one or more intra-layer Tf-SfD operations, etc.) to achieve an accuracy of 72.81, which is a gain of 3.75 over the independent trained baseline and a gain of 2.04 over the DML technique. Advantageously, the model training circuitry 104A-E can train an AI/ML model, such as ResNet20, with reduced training costs and improved performance (e.g., improved accuracy, recognition rates, etc.) with respect to conventional one-stage machine learning model training techniques.

The illustrated example of FIG. 10D is a fourth table 1040 that depicts accuracies (e.g., recognition rates) of a ResNet18 model using one-stage and two-stage machine learning model training techniques (e.g., knowledge distillation (KD) techniques). The fourth table 1040 depicts accuracies of the ResNet18 model after being trained with an independent trained baseline (depicted by Student and Teacher columns identified by reference numeral 1042, 1044). The fourth table 1040 depicts accuracies of the ResNet18 model after being trained with conventional one-stage KD techniques (e.g., AT, KD, SP, CC, CRD) and conventional one-stage KD techniques (e.g., DML, ONE, AFD, PCL). The fourth table 1040 depicts accuracies of the ResNet18 model after being trained with Tf-SfD techniques as described herein (e.g., by executing one or more inter-layer Tf-SfD operations, one or more intra-layer Tf-SfD operations, etc.).

By way of example, a ResNet18 model can be trained with an independent trained baseline to achieve an accuracy of 69.75 (e.g., 69.75%) for the student model. The same ResNet18 model can be trained with a conventional two-stage KD technique, such as AT, to achieve an accuracy of 70.59. The model training circuitry 104A-E can train the same ResNet20 model with Tf-SfD techniques as described herein (e.g., by executing one or more inter-layer Tf-SfD operations, one or more intra-layer Tf-SfD operations, etc.) to achieve an accuracy of 71.72, which is a gain of 1.97 over the independent trained baseline and a gain of 1.13 over the AT technique. Advantageously, the model training circuitry 104A-E can train an AI/ML model, such as ResNet18, with reduced training costs and improved performance (e.g., improved accuracy, recognition rates, etc.) with respect to conventional machine learning model training techniques.

FIG. 11 is a block diagram of an example processor platform 1100 structured to execute and/or instantiate the example machine readable instructions and/or the example operations of FIGS. 6-9 to implement the example model training circuitry 104A-E of FIGS. 1-5. The processor platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1100 of the illustrated example includes processor circuitry 1112. The processor circuitry 1112 of the illustrated example is hardware. For example, the processor circuitry 1112 can be implemented by one or more integrated circuits, logic circuits, FPGAs, microprocessors, CPUs, GPUs, DSPs, and/or microcontrollers from any desired family or manufacturer. The processor circuitry 1112 may be implemented by one or more semiconductor based (e.g., silicon based) devices. In this example, the processor circuitry 1112 implements the example configuration determination circuitry 520 (identified by CONFIG DETERM CIRCUITRY), the example model execution circuitry 530 (identified by MODEL EXEC CIRCUITRY), the example operation selection circuitry 540 (identified by OPER SELECT CIRCUITRY), the example layer selection circuitry 550 (identified by LAYER SELECT CIRCUITRY), the example feature channel selection circuitry 560 (identified by FEAT CH SELECT CIRCUITRY), the example loss function determination circuitry 570 (identified by LOSS FX DETERM CIRCUITRY), and the example executable generation circuitry 580 (identified by EXECUTABLE GEN CIRCUITRY) of FIG. 5.

The processor circuitry 1112 of the illustrated example includes a local memory 1113 (e.g., a cache, registers, etc.). The processor circuitry 1112 of the illustrated example is in communication with a main memory including a volatile memory 1114 and a non-volatile memory 1116 by a bus 1118. In some examples, the bus 1118 implements the example bus 505 of FIG. 5. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117.

The processor platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In this example, the interface circuitry 1120 implements the example interface circuitry 510 of FIG. 5.

In the illustrated example, one or more input devices 1122 are connected to the interface circuitry 1120. The input device(s) 1122 permit(s) a user to enter data and/or commands into the processor circuitry 1112. The input device(s) 1122 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1100 of the illustrated example also includes one or more mass storage devices 1128 to store software and/or data. Examples of such mass storage devices 1128 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives. In this example, the one or more mass storage devices 1128 implement the example datastore 590 of FIG. 5, which includes the example training data 592, the example configuration data 594 (identified by CONFIG DATA), the example machine learning model 596 (identified by ML MODEL), and the example machine learning executable 598 (identified by ML EXECUTABLE) of FIG. 5.

The machine executable instructions 1132, which may be implemented by the machine readable instructions of FIGS. 6-9, may be stored in the mass storage device 1128, in the volatile memory 1114, in the non-volatile memory 1016, and/or on a removable non-transitory computer readable storage medium such as a CD or DVD.

The processor platform 1100 of the illustrated example of FIG. 11 includes example acceleration circuitry 1138, which includes an example graphics processing unit (GPU) 1140, an example vision processing unit (VPU) 1142, and an example neural network processor 1144. In this example, the GPU 1140, the VPU 1142, and the neural network processor 1144 are in communication with different hardware of the processor platform 1100, such as the volatile memory 1114, the non-volatile memory 1116, etc., via the bus 1118. In this example, the neural network processor 1144 may be implemented by one or more integrated circuits, logic circuits, microprocessors, GPUs, DSPs, or controllers from any desired family or manufacturer that can be used to execute an AI model, such as a neural network, which may be implemented by the machine learning model 596. In some examples, one or more of the example configuration determination circuitry 520, the example model execution circuitry 530, the example operation selection circuitry 540, the example layer selection circuitry 550, the example feature channel selection circuitry 560, the example loss function determination circuitry 570, and/or the example executable generation circuitry 580 can be implemented in or with at least one of the GPU 1140, the VPU 1142, or the neural network processor 1144 instead of or in addition to the processor circuitry 1112.

In some examples, the GPU 1140 may implement the first hardware accelerator 108, the second hardware accelerator 110, and/or the general purpose processor circuitry 112 of FIG. 1. In some examples, the VPU 1142 may implement the first hardware accelerator 108, the second hardware accelerator 110, and/or the general purpose processor circuitry 112 of FIG. 1. In some examples, the neural network processor 1144 may implement the first hardware accelerator 108, the second hardware accelerator 110, and/or the general purpose processor circuitry 112 of FIG. 1.

FIG. 12 is a block diagram of an example implementation of the processor circuitry 1112 of FIG. 11. In this example, the processor circuitry 1112 of FIG. 11 is implemented by a general purpose microprocessor 1200. The general purpose microprocessor circuitry 1200 executes some or all of the machine readable instructions of the flowcharts of FIGS. 6-9 to effectively instantiate the model training circuitry 104A-E of FIGS. 1-5 as logic circuits to perform the operations corresponding to those machine readable instructions. In some such examples, the model training circuitry 104A-E of FIGS. 1-5 is instantiated by the hardware circuits of the microprocessor 1200 in combination with the instructions. For example, the microprocessor 1200 may implement multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowcharts of FIGS. 6-9.

The cores 1202 may communicate by a first example bus 1204. In some examples, the first bus 1204 may implement a communication bus to effectuate communication associated with one(s) of the cores 1202. For example, the first bus 1204 may implement at least one of an Inter-Integrated Circuit (I2C) bus, a Serial Peripheral Interface (SPI) bus, a PCI bus, or a PCIe bus. Additionally or alternatively, the first bus 1204 may implement any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2_cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the L1 cache 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating point operations. In yet other examples, the AL circuitry 1216 may include first AL circuitry that performs integer based operations and second AL circuitry that performs floating point operations. In some examples, the AL circuitry 1216 may be referred to as an Arithmetic Logic Unit (ALU). The registers 1218 are semiconductor-based structures to store data and/or instructions such as results of one or more of the operations performed by the AL circuitry 1216 of the corresponding core 1202. For example, the registers 1218 may include vector register(s), SIMD register(s), general purpose register(s), flag register(s), segment register(s), machine specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure including distributed throughout the core 1202 to shorten access time. The second bus 1222 may implement at least one of an I2C bus, a SPI bus, a PCI bus, or a PCIe bus

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 13 is a block diagram of another example implementation of the processor circuitry 1112 of FIG. 11. In this example, the processor circuitry 1112 is implemented by FPGA circuitry 1300. The FPGA circuitry 1300 can be used, for example, to perform operations that could otherwise be performed by the example microprocessor 1200 of FIG. 12 executing corresponding machine readable instructions. However, once configured, the FPGA circuitry 1300 instantiates the machine readable instructions in hardware and, thus, can often execute the operations faster than they could be performed by a general purpose microprocessor executing the corresponding software.

More specifically, in contrast to the microprocessor 1200 of FIG. 12 described above (which is a general purpose device that may be programmed to execute some or all of the machine readable instructions represented by the flowcharts of FIGS. 6-9 but whose interconnections and logic circuitry are fixed once fabricated), the FPGA circuitry 1300 of the example of FIG. 13 includes interconnections and logic circuitry that may be configured and/or interconnected in different ways after fabrication to instantiate, for example, some or all of the machine readable instructions represented by the flowcharts of FIGS. 6-9. In particular, the FPGA 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the software represented by the flowcharts of FIGS. 6-9. As such, the FPGA circuitry 1300 may be structured to effectively instantiate some or all of the machine readable instructions of the flowcharts of FIGS. 6-9. as dedicated logic circuits to perform the operations corresponding to those software instructions in a dedicated manner analogous to an ASIC. Therefore, the FPGA circuitry 1300 may perform the operations corresponding to the some or all of the machine readable instructions of FIGS. 6-9 faster than the general purpose microprocessor can execute the same.

In the example of FIG. 13, the FPGA circuitry 1300 is structured to be programmed (and/or reprogrammed one or more times) by an end user by a hardware description language (HDL) such as Verilog. The FPGA circuitry 1300 of FIG. 13, includes example input/output (I/O) circuitry 1302 to obtain and/or output data to/from example configuration circuitry 1304 and/or external hardware (e.g., external hardware circuitry) 1306. For example, the configuration circuitry 1304 may implement interface circuitry that may obtain machine readable instructions to configure the FPGA circuitry 1300, or portion(s) thereof. In some such examples, the configuration circuitry 1304 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1306 may implement the microprocessor 1200 of FIG. 12. The FPGA circuitry 1300 also includes an array of example logic gate circuitry 1308, a plurality of example configurable interconnections 1310, and example storage circuitry 1312. The logic gate circuitry 1308 and interconnections 1310 are configurable to instantiate one or more operations that may correspond to at least some of the machine readable instructions of FIGS. 6-9 and/or other desired operations. The logic gate circuitry 1308 shown in FIG. 13 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations. The logic gate circuitry 1308 may include other electrical structures such as look-up tables (LUTs), registers (e.g., flip-flops or latches), multiplexers, etc.

The interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example Dedicated Operations Circuitry 1314. In this example, the Dedicated Operations Circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the processor circuitry 1112 of FIG. 11, many other approaches are contemplated. For example, as mentioned above, modern FPGA circuitry may include an on-board CPU, such as one or more of the example CPU 1320 of FIG. 13. Therefore, the processor circuitry 1112 of FIG. 11 may additionally be implemented by combining the example microprocessor 1200 of FIG. 12 and the example FPGA circuitry 1300 of FIG. 13. In some such hybrid examples, a first portion of the machine readable instructions represented by the flowcharts of FIGS. 6-9 may be executed by one or more of the cores 1202 of FIG. 12, a second portion of the machine readable instructions represented by the flowcharts of FIGS. 6-9 may be executed by the FPGA circuitry 1300 of FIG. 13, and/or a third portion of the machine readable instructions represented by the flowcharts of FIGS. 6-9 may be executed by an ASIC. It should be understood that some or all of the model training circuitry 104A-E of FIGS. 1-5 may, thus, be instantiated at the same or different times. Some or all of the circuitry may be instantiated, for example, in one or more threads executing concurrently and/or in series. Moreover, in some examples, some or all of the model training circuitry 104A-E of FIGS. 1-5 may be implemented within one or more virtual machines and/or containers executing on the microprocessor.

In some examples, the processor circuitry 1112 of FIG. 11 may be in one or more packages. For example, the processor circuitry 1200 of FIG. 12 and/or the FPGA circuitry 1300 of FIG. 13 may be in one or more packages. In some examples, an XPU may be implemented by the processor circuitry 1112 of FIG. 11, which may be in one or more packages. For example, the XPU may include a CPU in one package, a DSP in another package, a GPU in yet another package, and an FPGA in still yet another package.

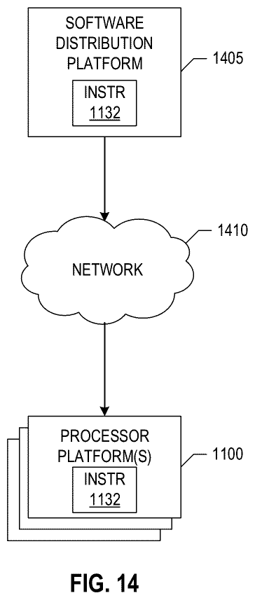

A block diagram illustrating an example software distribution platform 1405 to distribute software such as the example machine readable instructions 1132 of FIG. 11 to hardware devices owned and/or operated by third parties is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine readable instructions 1132, which may correspond to the example machine readable instructions and/or the example operations 600, 700, 800, 900 of FIGS. 6-9, as described above. The one or more servers of the example software distribution platform 1405 are in communication with a network 1410, which may correspond to any one or more of the Internet and/or any of the example networks 128, 1126 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1132 from the software distribution platform 1405. For example, the software, which may correspond to the example machine readable instructions and/or the example operations 600, 700, 800, 900 of FIGS. 6-9, may be downloaded to the example processor platform 1100, which is to execute the machine readable instructions 1132 to implement the example model training circuitry 104A-E of FIGS. 1-5. In some examples, one or more servers of the software distribution platform 1405 periodically offer, transmit, and/or force updates to the software (e.g., the example machine readable instructions 1132 of FIG. 11) to ensure improvements, patches, updates, etc., are distributed and applied to the software at the end user devices.

From the foregoing, it will be appreciated that example systems, methods, apparatus, and articles of manufacture have been disclosed for a user-friendly, parameter-free, powerful and efficient knowledge distillation technique without the need of teacher machine learning models, which can require longer training costs and complex parameter tunings. Disclosed examples achieve improved performance with respect to model accuracy and training efficiency compared to conventional teacher-student machine learning model training techniques. Disclosed examples are applicable to any kind of neural network (e.g., a DNN) and various AI/ML tasks and workloads. Disclosed examples can convert computationally intensive neural networks (e.g., DNNs) into lightweight neural networks with relatively similar accuracy, which, from a hardware perspective, can achieve the replacement of deep, sequential processing with parallel, distributed processing. Advantageously, this structural conversion can facilitate the acceleration of AI/ML training and inference using general-purpose processor circuitry (e.g., multi-core CPU, GPUs, etc.). Disclosed systems, methods, apparatus, and articles of manufacture improve the efficiency of using a computing device by training an AI/ML model with reduced training costs and improved accuracy and/or performance. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture for teacher-free self-feature distillation training of machine learning models are disclosed herein. Further examples and combinations thereof include the following:

Example 1 includes an apparatus to improve model training, the apparatus comprising at least one memory, instructions, and processor circuitry to at least one of execute or instantiate the instructions to perform a first comparison of (i) a first group of a first set of feature channels corresponding to a first layer of a machine learning model and (ii) a second group of the first set of feature channels, perform a second comparison of (iii) a first group of a second set of feature channels corresponding to a second layer of the machine learning model and one of (iv) a third group of the first set of feature channels or a first group of a third set of feature channels corresponding to a third layer of the machine learning model, adjust one or more parameters of the machine learning model based on at least one of the first comparison or the second comparison, and in response to a determination that an error value associated with the machine learning model satisfies a threshold, deploy the machine learning model to execute a workload based on the one or more parameters.

In Example 2, the subject matter of Example 1 can optionally include that the first set of feature channels includes a first feature channel with first output values and a second feature channel with second output values, the error value is a first error value, and the processor circuitry is to determine a first sum of the first output values and a second sum of the second output values, group the first feature channel into the first group of the first set of feature channels and the second feature channel into the second group of the first set of feature channels based on the first sum being greater than the second sum, and determine a second error value of a loss function based on differences between the first group and the second group of the first set of feature channels.

In Example 3, the subject matter of Examples 1-2 can optionally include that the processor circuitry is to determine that the first feature channel has a first number of salient features greater than a second number of salient features of the second feature channel based on the first sum being greater than the second sum.

In Example 4, the subject matter of Examples 1-3 can optionally include that the first set of feature channels includes a first feature channel with first output values and a second feature channel with second output values, the determination is a first determination, and the processor circuitry is to in response to a second determination that the error value does not satisfy the threshold, adjust the one or more parameters to cause the second output values of the second feature channel to mimic the first output values of the first feature channel, and determine the error value based on the adjusted one or more parameters.

In Example 5, the subject matter of Examples 1-4 can optionally include that the second set of feature channels includes a first feature channel with first output values and a second feature channel with second output values, the third set of feature channels includes a third feature channel, and the processor circuitry is to group the third feature channel into the first group of the third set, determine a first sum of the first output values and a second sum of the second output values, group the first feature channel into the first group of the second set based on the first sum being greater than the second sum, and determine the error value of a loss function based on differences between the first group of the third set and the first group of the second set.

In Example 6, the subject matter of Examples 1-5 can optionally include that the first set of feature channels includes a first feature channel with a first size and the third set of feature channels includes a second feature channel with a second size, the second size less than the first size, and the processor circuitry is to down sample the first feature channel to the second size, the error value based on the first feature channel having the second size.

In Example 7, the subject matter of Examples 1-6 can optionally include that the down sampling of the first feature channel includes at least one of an average pooling operation on the first feature channel, a maximum pooling operation on the first feature channel, or a change in stride length associated with a convolution operation to generate the first feature channel.

In Example 8, the subject matter of Examples 1-7 can optionally include that the machine learning model is a teacher-free neural network.

Example 9 includes an apparatus to improve model training, the apparatus comprising means for comparing, the means for comparing to perform a first comparison of (i) a first group of a first set of feature channels corresponding to a first layer of a machine learning model and (ii) a second group of the first set of feature channels, and perform a second comparison of (iii) a first group of a second set of feature channels corresponding to a second layer of the machine learning model and one of (iv) a third group of the first set of feature channels or a first group of a third set of feature channels corresponding to a third layer of the machine learning model, means for adjusting one or more parameters of the machine learning model based on at least one of the first comparison or the second comparison, and means for deploying the machine learning model to execute a workload based on the one or more parameters, the means for deploying to deploy the machine learning model in response to a determination that an error value associated with the machine learning model satisfies a threshold.

In Example 10, the subject matter of Example 9 can optionally include that the first set of feature channels includes a first feature channel with first output values and a second feature channel with second output values, the error value is a first error value, and the apparatus further including means for determining to determine a first sum of the first output values and a second sum of the second output values, and group the first feature channel into the first group of the first set of feature channels and the second feature channel into the second group of the first set of feature channels based on the first sum being greater than the second sum, and the means for comparing to determine a second error value of a loss function based on differences between the first group and the second group of the first set of feature channels.

In Example 11, the subject matter of Examples 9-10 can optionally include that the means for determining is to determine that the first feature channel has a first number of salient features greater than a second number of salient features of the second feature channel based on the first sum being greater than the second sum.

In Example 12, the subject matter of Examples 9-11 can optionally include that the first set of feature channels includes a first feature channel with first output values and a second feature channel with second output values, the determination is a first determination, and wherein the means for adjusting is to, in response to a second determination that the error value does not satisfy the threshold, adjust the one or more parameters to cause the second output values of the second feature channel to mimic the first output values of the first feature channel, and the means for comparing is to determine the error value based on the adjusted one or more parameters.

In Example 13, the subject matter of Examples 9-12 can optionally include that the second set of feature channels includes a first feature channel with first output values and a second feature channel with second output values, the third set of feature channels includes a third feature channel, and the apparatus further including means for determining to group the third feature channel into the first group of the third set, determine a first sum of the first output values and a second sum of the second output values, group the first feature channel into the first group of the second set based on the first sum being greater than the second sum, and the means for comparing to determine the error value of a loss function based on differences between the first group of the third set and the first group of the second set.

In Example 14, the subject matter of Examples 9-13 can optionally include that the first set of feature channels includes a first feature channel with a first size and the third set of feature channels includes a second feature channel with a second size, the second size less than the first size, and the apparatus further including means for down sampling the first feature channel to the second size, the error value based on the first feature channel having the second size.

In Example 15, the subject matter of Examples 9-14 can optionally include that the down sampling of the first feature channel includes at least one of an average pooling operation on the first feature channel, a maximum pooling operation on the first feature channel, or a change in stride length associated with a convolution operation to generate the first feature channel.

In Example 16, the subject matter of Examples 9-15 can optionally include that the machine learning model is a teacher-free neural network.

Example 17 includes at least one non-transitory machine readable storage medium comprising instructions that, when executed, cause processor circuitry to at least perform a first comparison of (i) a first group of a first set of feature channels corresponding to a first layer of a machine learning model and (ii) a second group of the first set of feature channels, perform a second comparison of (iii) a first group of a second set of feature channels corresponding to a second layer of the machine learning model and one of (iv) a third group of the first set of feature channels or a first group of a third set of feature channels corresponding to a third layer of the machine learning model, adjust one or more parameters of the machine learning model based on at least one of the first comparison or the second comparison, and in response to a determination that an error value associated with the machine learning model satisfies a threshold, deploy the machine learning model to execute a workload based on the one or more parameters.

In Example 18, the subject matter of Example 17 can optionally include that the first set of feature channels includes a first feature channel with first output values and a second feature channel with second output values, the error value is a first error value, and the instructions, when executed, cause the processor circuitry to determine a first sum of the first output values and a second sum of the second output values, group the first feature channel into the first group of the first set of feature channels and the second feature channel into the second group of the first set of feature channels based on the first sum being greater than the second sum, and determine a second error value of a loss function based on differences between the first group and the second group of the first set of feature channels.

In Example 19, the subject matter of Examples 17-18 can optionally include that the instructions, when executed, cause the processor circuitry to determine that the first feature channel has a first number of salient features greater than a second number of salient features of the second feature channel based on the first sum being greater than the second sum.

In Example 20, the subject matter of Examples 17-19 can optionally include that the first set of feature channels includes a first feature channel with first output values and a second feature channel with second output values, the determination is a first determination, and the instructions, when executed, cause the processor circuitry to in response to a second determination that the error value does not satisfy the threshold, adjust the one or more parameters to cause the second output values of the second feature channel to mimic the first output values of the first feature channel, and determine the error value based on the adjusted one or more parameters.

In Example 21, the subject matter of Examples 17-20 can optionally include that the second set of feature channels includes a first feature channel with first output values and a second feature channel with second output values, the third set of feature channels includes a third feature channel, and the instructions, when executed, cause the processor circuitry to group the third feature channel into the first group of the third set, determine a first sum of the first output values and a second sum of the second output values, group the first feature channel into the first group of the second set based on the first sum being greater than the second sum, and determine the error value of a loss function based on differences between the first group of the third set and the first group of the second set.

In Example 22, the subject matter of Examples 17-21 can optionally include that the first set of feature channels includes a first feature channel with a first size and the third set of feature channels includes a second feature channel with a second size, the second size less than the first size, and the instructions, when executed, cause the processor circuitry to down sample the first feature channel to the second size, the error value based on the first feature channel having the second size.

In Example 23, the subject matter of Examples 17-22 can optionally include that the down sampling of the first feature channel includes at least one of an average pooling operation on the first feature channel, a maximum pooling operation on the first feature channel, or a change in stride length associated with a convolution operation to generate the first feature channel.

In Example 24, the subject matter of Examples 17-23 can optionally include that the machine learning model is a teacher-free neural network.

Example 25 includes a method to improve model training, the method comprising performing a first comparison of (i) a first group of a first set of feature channels corresponding to a first layer of a machine learning model and (ii) a second group of the first set of feature channels, performing a second comparison of (iii) a first group of a second set of feature channels corresponding to a second layer of the machine learning model and one of (iv) a third group of the first set of feature channels or a first group of a third set of feature channels corresponding to a third layer of the machine learning model, adjusting one or more parameters of the machine learning model based on at least one of the first comparison or the second comparison, and in response to determining that an error value associated with the machine learning model satisfies a threshold, deploying the machine learning model to execute a workload based on the one or more parameters.

In Example 26, the subject matter of Example 25 can optionally include that the first set of feature channels includes a first feature channel with first output values and a second feature channel with second output values, the error value is a first error value, and the method further including determining a first sum of the first output values and a second sum of the second output values, grouping the first feature channel into the first group of the first set of feature channels and the second feature channel into the second group of the first set of feature channels based on the first sum being greater than the second sum, and determining a second error value of a loss function based on differences between the first group and the second group of the first set of feature channels.

In Example 27, the subject matter of Examples 25-26 can optionally include determining that the first feature channel has a first number of salient features greater than a second number of salient features of the second feature channel based on the first sum being greater than the second sum.

In Example 28, the subject matter of Examples 25-27 can optionally include that the first set of feature channels includes a first feature channel with first output values and a second feature channel with second output values, and the method further including in response to determining that the error value does not satisfy the threshold, adjusting the one or more parameters to cause the second output values of the second feature channel to mimic the first output values of the first feature channel, and determining the error value based on the adjusted one or more parameters.

In Example 29, the subject matter of Examples 25-28 can optionally include that the second set of feature channels includes a first feature channel with first output values and a second feature channel with second output values, the third set of feature channels includes a third feature channel, and the method further including grouping the third feature channel into the first group of the third set, determining a first sum of the first output values and a second sum of the second output values, grouping the first feature channel into the first group of the second set based on the first sum being greater than the second sum, and determining the error value of a loss function based on differences between the first group of the third set and the first group of the second set.

In Example 30, the subject matter of Examples 25-29 can optionally include that the first set of feature channels includes a first feature channel with a first size and the third set of feature channels includes a second feature channel with a second size, the second size less than the first size, and the method further including down sampling the first feature channel to the second size, the error value based on the first feature channel having the second size.

In Example 31, the subject matter of Examples 25-30 can optionally include that the down sampling of the first feature channel includes at least one of an average pooling operation on the first feature channel, a maximum pooling operation on the first feature channel, or a change in stride length associated with a convolution operation to generate the first feature channel.

In Example 32, the subject matter of Examples 25-31 can optionally include that the machine learning model is a teacher-free neural network.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus to improve model training, the apparatus comprising:
at least one memory;
instructions; and
processor circuitry to at least one of execute or instantiate the instructions to:
perform a first comparison of (i) a first group of a first set of feature channels corresponding to a first layer of a machine learning model and (ii) a second group of the first set of feature channels;
perform a second comparison of (iii) a first group of a second set of feature channels corresponding to a second layer of the machine learning model and one of (iv) a third group of the first set of feature channels or a first group of a third set of feature channels corresponding to a third layer of the machine learning model;
adjust one or more parameters of the machine learning model based on at least one of the first comparison or the second comparison; and
in response to a determination that an error value associated with the machine learning model satisfies a threshold, deploy the machine learning model to execute a workload based on the one or more parameters.

2. The apparatus of claim 1, wherein the first set of feature channels includes a first feature channel with first output values and a second feature channel with second output values, the error value is a first error value, and the processor circuitry is to:
determine a first sum of the first output values and a second sum of the second output values;
group the first feature channel into the first group of the first set of feature channels and the second feature channel into the second group of the first set of feature channels based on the first sum being greater than the second sum; and
determine a second error value of a loss function based on differences between the first group and the second group of the first set of feature channels.

3. The apparatus of claim 2, wherein the processor circuitry is to determine that the first feature channel has a first number of salient features greater than a second number of salient features of the second feature channel based on the first sum being greater than the second sum.

4. The apparatus of claim 1, wherein the first set of feature channels includes a first feature channel with first output values and a second feature channel with second output values, the determination is a first determination, and the processor circuitry is to:
in response to a second determination that the error value does not satisfy the threshold, adjust the one or more parameters to cause the second output values of the second feature channel to mimic the first output values of the first feature channel; and
determine the error value based on the adjusted one or more parameters.

5. The apparatus of claim 1, wherein the second set of feature channels includes a first feature channel with first output values and a second feature channel with second output values, the third set of feature channels includes a third feature channel, and the processor circuitry is to:
group the third feature channel into the first group of the third set;
determine a first sum of the first output values and a second sum of the second output values;
group the first feature channel into the first group of the second set based on the first sum being greater than the second sum; and
determine the error value of a loss function based on differences between the first group of the third set and the first group of the second set.

6. The apparatus of claim 1, wherein the first set of feature channels includes a first feature channel with a first size and the third set of feature channels includes a second feature channel with a second size, the second size less than the first size, and the processor circuitry is to down sample the first feature channel to the second size, the error value based on the first feature channel having the second size.

7. The apparatus of claim 6, wherein the down sampling of the first feature channel includes at least one of an average pooling operation on the first feature channel, a maximum pooling operation on the first feature channel, or a change in stride length associated with a convolution operation to generate the first feature channel.

8. The apparatus of claim 1, wherein the machine learning model is a teacher-free neural network.

9. (canceled)

10. (canceled)

11. (canceled)

12. (canceled)

13. (canceled)

14. (canceled)

15. (canceled)

16. (canceled)

17. At least one non-transitory machine readable storage medium comprising instructions that, when executed, cause processor circuitry to at least:
perform a first comparison of (i) a first group of a first set of feature channels corresponding to a first layer of a machine learning model and (ii) a second group of the first set of feature channels;
perform a second comparison of (iii) a first group of a second set of feature channels corresponding to a second layer of the machine learning model and one of (iv) a third group of the first set of feature channels or a first group of a third set of feature channels corresponding to a third layer of the machine learning model;
adjust one or more parameters of the machine learning model based on at least one of the first comparison or the second comparison; and
in response to a determination that an error value associated with the machine learning model satisfies a threshold, deploy the machine learning model to execute a workload based on the one or more parameters.

18. The at least one non-transitory machine readable storage medium of claim 17, wherein the first set of feature channels includes a first feature channel with first output values and a second feature channel with second output values, the error value is a first error value, and the instructions, when executed, cause the processor circuitry to:
determine a first sum of the first output values and a second sum of the second output values;
group the first feature channel into the first group of the first set of feature channels and the second feature channel into the second group of the first set of feature channels based on the first sum being greater than the second sum; and
determine a second error value of a loss function based on differences between the first group and the second group of the first set of feature channels.

19. The at least one non-transitory machine readable storage medium of claim 18, wherein the instructions, when executed, cause the processor circuitry to determine that the first feature channel has a first number of salient features greater than a second number of salient features of the second feature channel based on the first sum being greater than the second sum.

20. The at least one non-transitory machine readable storage medium of claim 17, wherein the first set of feature channels includes a first feature channel with first output values and a second feature channel with second output values, the determination is a first determination, and the instructions, when executed, cause the processor circuitry to:
in response to a second determination that the error value does not satisfy the threshold, adjust the one or more parameters to cause the second output values of the second feature channel to mimic the first output values of the first feature channel; and
determine the error value based on the adjusted one or more parameters.

21. The at least one non-transitory machine readable storage medium of claim 17, wherein the second set of feature channels includes a first feature channel with first output values and a second feature channel with second output values, the third set of feature channels includes a third feature channel, and the instructions, when executed, cause the processor circuitry to:
group the third feature channel into the first group of the third set;
determine a first sum of the first output values and a second sum of the second output values;
group the first feature channel into the first group of the second set based on the first sum being greater than the second sum; and
determine the error value of a loss function based on differences between the first group of the third set and the first group of the second set.

22. The at least one non-transitory machine readable storage medium of claim 17, wherein the first set of feature channels includes a first feature channel with a first size and the third set of feature channels includes a second feature channel with a second size, the second size less than the first size, and the instructions, when executed, cause the processor circuitry to down sample the first feature channel to the second size, the error value based on the first feature channel having the second size.

23. The at least one non-transitory machine readable storage medium of claim 22, wherein the down sampling of the first feature channel includes at least one of an average pooling operation on the first feature channel, a maximum pooling operation on the first feature channel, or a change in stride length associated with a convolution operation to generate the first feature channel

24. The at least one non-transitory machine readable storage medium of claim 17, wherein the machine learning model is a teacher-free neural network.

25. A method to improve model training, the method comprising:
performing a first comparison of (i) a first group of a first set of feature channels corresponding to a first layer of a machine learning model and (ii) a second group of the first set of feature channels;
performing a second comparison of (iii) a first group of a second set of feature channels corresponding to a second layer of the machine learning model and one of (iv) a third group of the first set of feature channels or a first group of a third set of feature channels corresponding to a third layer of the machine learning model;
adjusting one or more parameters of the machine learning model based on at least one of the first comparison or the second comparison; and
in response to determining that an error value associated with the machine learning model satisfies a threshold, deploying the machine learning model to execute a workload based on the one or more parameters.

26. The method of claim 25, wherein the first set of feature channels includes a first feature channel with first output values and a second feature channel with second output values, the error value is a first error value, and the method further including:
determining a first sum of the first output values and a second sum of the second output values;
grouping the first feature channel into the first group of the first set of feature channels and the second feature channel into the second group of the first set of feature channels based on the first sum being greater than the second sum; and
determining a second error value of a loss function based on differences between the first group and the second group of the first set of feature channels.

27. The method of claim 26, further including determining that the first feature channel has a first number of salient features greater than a second number of salient features of the second feature channel based on the first sum being greater than the second sum.

28. The method of claim 25, wherein the first set of feature channels includes a first feature channel with first output values and a second feature channel with second output values, and the method further including:
in response to determining that the error value does not satisfy the threshold, adjusting the one or more parameters to cause the second output values of the second feature channel to mimic the first output values of the first feature channel; and
determining the error value based on the adjusted one or more parameters.

29. (canceled)

30. (canceled)

31. (canceled)

32. (canceled)
